(19) United States
(12) Patent Application Publication
(10) Pub. No.: US 2026/0277835 A1
(43) Pub. Date: Sep. 17, 2026

(54) PERIPHERAL COMPONENT INTERCONNECT EXPRESS (PCIe) SYSTEM PERFORMING LOW POWER MANAGEMENT AND METHOD OF OPERATING THE SAME

(71) Applicant: SK hynix Inc., Icheon-si (KR)

(72) Inventors: Yong Tae JEON, Icheon-si (KR); Ji Woon YANG, Icheon-si (KR)

(21) Appl. No.: 19/677,212

(22) Filed: May 14, 2026

Related U.S. Application Data
(63) Continuation of application No. 17/707,744, filed on Mar. 29, 2022.
Application No. 17/707,744 is a continuation-in-part of application No. 17/522,843, filed on Nov. 9, 2021, now Pat. No. 11,960,424.
Application No. 17/707,744 is a continuation-in-part of application No. 17/522,827, filed on Nov. 9, 2021, now Pat. No. 11,782,497.
Application No. 17/707,744 is a continuation-in-part of application No. 17/522,810, filed on Nov. 9, 2021, now Pat. No. 11,789,658.

(30) Foreign Application Priority Data
Apr. 13, 2021 (KR) 10-2021-0048080
Apr. 13, 2021 (KR) 10-2021-0048084
Jun. 1, 2021 (KR) 10-2021-0070686

(51) Int. Cl. G06F 13/28; G06F 1/3296; G06F 13/42

(52) U.S. Cl. CPC G06F 13/28; G06F 1/3296; G06F 13/4221; G06F 2213/0026

(57) ABSTRACT

The present technology relates to an electronic device. A computing system may include a host and a peripheral component interconnect express (PCIe) device connected the host through a link. The host comprises a host memory and a storage device driver. The host memory may store information on a first target command to be executed in the PCIe device. The storage device driver may provide the first target command to the host memory and a notification message indicating that the first target command is stored in the host memory to the PCIe device. The PCIe device may request the host memory to register an address of the host memory in which a second target command to be executed in the PCIe device is stored through a preset protocol.

### CROSS-REFERENCE TO RELATED APPLICATIONS

This present application is a continuation of U.S. Patent Application No. 17/707,744, filed on March 29, 2022, which is a continuation-in-part of, claims priority to and benefits of, the following three patent applications:
1. U.S. Patent Application No. 17/522,810 and now issued as U.S. Patent No. 11,789,658, which claims priority to Korean patent application number 10-2021-0048080, filed on April 13, 2021 and Korean patent application number 10-2021-0070686, filed on June 1, 2021.
2. U.S. Patent Application No. 17/522,827 and now issued as U.S. Patent No. 11,782,497, which claims priority to Korean patent application number 10-2021-0070686, filed on June 1, 2021.
3. U.S. Patent Application No. 17/522,843 and now issued as U.S. Patent No. 11,960,424, which claims priority to Korean patent application number 10-2021-0048084, filed on April 13, 2021.

The entire contents of the before-mentioned patent applications are incorporated herein by reference as a part of the disclosure of this application.

### TECHNICAL FIELD

The technology and implementations disclosed in this patent document relates to an electronic device, and more particularly, to a PCIe system and a method of operating the same.

### BACKGROUND

A peripheral component interconnect express (PCIe) is a serial structure of interface for data communication. A PCIe-based storage device supports multi-port and multi-function. The PCIe-based storage device may be virtualized and non-virtualized, and may achieve quality of service (QoS) of a host I/O command through one or more PCIe functions.

A storage device is a device that stores data under control of a host device such as a computer or a smartphone. A storage device may include a memory device in which data is stored and a memory controller controlling the memory device. The memory device is divided into a volatile memory device and a non-volatile memory device.

The volatile memory device is a device that stores data only when power is supplied and loses the stored data when the power supply is cut off. The volatile memory device includes a static random access memory (SRAM), a dynamic random access memory (DRAM), and the like.

The non-volatile memory device is a device that does not lose data even though power is cut off. The non-volatile memory device includes a read only memory (ROM), a programmable ROM (PROM), an electrically programmable ROM (EPROM), an electrically erasable and programmable ROM (EEPROM), a flash memory, and others.

### SUMMARY

Various embodiments of the disclosed technology provide a PCIe system and a method of operating the same, which reduces a time to fetch a command by registering a PCIe lightweight notification (LN) and prefetching the command.

According to an embodiment of the present disclosure, a peripheral component interconnect express (PCIe) system may include a PCIe interface device, a host, and a peripheral component interconnect express (PCIe) device connected to the host through the interface device. The host may include a host memory configured to store information on a command to be executed on the PCIe device and a command that has been executed on the PCIe device, and an NVMe driver configured to transmit the command to be executed on the PCIe device to the host memory, and output a doorbell signal indicating that the command to be executed on the PCIe device has been stored in the host memory to the PCIe device. The PCIe device is configured to request to the host memory to register a lightweight notification (LN) registration indicating a position in which the command to be executed on the PCIe device is stored.

According to an embodiment of the present disclosure, a method of operating a system may include requesting, by the system including a host having a host memory and a a peripheral component interconnect express (PCIe) device connected to the host through a peripheral component interconnect express (PCIe) interface device, a PCIe lightweight notification (LN) registration indicating a position in which a command to be executed on the PCIe device is stored within a host memory included in the system, registering the LN, and storing the command to be executed on the PCIe device in the host memory.

According to the present technology, a PCIe system and a method of operating the same, which reduces a time to fetch a command by registering a PCIe lightweight notification (LN) and prefetching the command are provided.

According to an embodiment of the disclosed technology, a peripheral component interconnect express (PCIe) system may include a root complex configured to support a PCIe port, a memory connected to an input/output structure through the root complex, a switch connected to the root complex through a link and configured to transmit a transaction, and an end point connected to the switch through the link to transmit and receive a packet. The PCIe system may perform a link power management by changing a state of the link in response to a detection of an idle state of the link.

According to an embodiment of the disclosed technology, a method of operating a peripheral component interconnect express (PCIe) system comprises detecting an idle state of a link configured to transmit and receive a packet based on a measurement of a period in which no packet is transmitted and received through the link, and performing a link power management by changing a state of the link in response to the detecting of the idle state of the link.

According to the present technology, a PCIe system for performing PCIe link power management when an idle state of a PCIe link is sensed during a process of an NVMe command, and a method of operating the same are provided.

According to an embodiment of the present disclosure, a device may include a lane group, a command queue, and a link manager. The lane group may include a first lane and at least one or more second lanes to provide communications, each lane being configured to form a link for communicating with a host. The command queue may store commands for at least one direct memory access (DMA) device, the commands generated based on a request of the host. The link manager may, in response to detecting an event that an amount of the commands stored in the command queue being less than or equal to a reference value, change an operation mode from a first power mode to a second power mode in which power consumption is less than that of the first power mode, deactivate the at least one or more second lanes, and provide a second operation clock lower than a first operation clock to the at least one DMA device.

According to an embodiment of the present disclosure, a method of operating a peripheral component interconnect express (PCIe) interface device may comprise changing an operation mode from a first power mode to a second power mode in which power consumption is less than that of the first power mode in response to a first event that an amount of commands for at least one direct memory access (DMA) device generated based on a request of a host in communication with the PCIe interface through a link is less than or equal to a reference value, deactivating at least one or more lanes included in the PCIe interface device and providing a second operation clock lower than a first operation clock to the at least one DMA device.

According to the present technology, a PCIe interface device having improved power management performance, and a method of operating the same are provided.

According to an embodiment of the present disclosure, a peripheral component interconnect express (PCIe) interface device may include a lane group, a command queue, and a link manager. The lane group may comprise a default lane and at least one or more lanes forming a link for communication between a host and a direct memory access (DMA) device. The command queue may store commands for the DMA device generated based on a request of the host. The link manager may detect whether the link is in an idle state, and change power of the link from a normal state to a low power state when the link is detected in the idle state.

According to an embodiment of the present disclosure, a computing system may include a host and a peripheral component interconnect express (PCIe) device connected the host through a link. The host comprises a host memory and a storage device driver. The host memory may store information on a first target command to be executed in the PCIe device. The storage device driver may provide the first target command to the host memory and a notification message indicating that the first target command is stored in the host memory to the PCIe device. The PCIe device may request the host memory to register an address of the host memory in which a second target command to be executed in the PCIe device is stored through a preset protocol.

### BRIEF DESCRIPTION OF THE DRAWINGS

FIG. 1 is an example of a block diagram illustrating a computing system based on some implementations of the disclosed technology.

FIG. 2 is a diagram illustrating PCIe components based on an embodiment of the disclosed technology.

FIG. 3 is a diagram illustrating layers included in a PCIe interface device described with reference to FIG. 2.

FIG. 4 is a diagram illustrating a lane based on an embodiment of the disclosed technology.

FIG. 5 is a diagram illustrating a link training & status state machine (LTSSM).

FIG. 6A is a diagram illustrating a link training & status state machine (LTSSM) in relation to a link described with reference to FIG. 5.

FIG. 6B is a diagram illustrating sub states of L1 described with reference to FIG. 6A.

FIG. 7 is a diagram illustrating an example of a command process in a PCIe device based on some implementations of the disclosed technology.

FIG. 8 is a diagram illustrating an example of a command process of FIG. 7.

FIG. 9 is a diagram illustrating an example of a command process performed through an LN based on some implementations of the disclosed technology.

FIG. 10 is a diagram illustrating an example of a LN based on some implementations of the disclosed technology.

FIG. 11 is a diagram illustrating an example of an LN registration based on some implementations of the disclosed technology.

FIG. 12 is a diagram illustrating examples of command pre-fetch and command fetch after an LN registration based on some implementations of the disclosed technology.

FIG. 13 is a diagram illustrating latency at an end of a low power state based on some implementations of the disclosed technology.

FIG. 14 is a diagram illustrating an end of the low power state through the LN registration based on some implementations of the disclosed technology.

FIG. 15 is a diagram illustrating an operation of a PCIe device based on some implementations of the disclosed technology.

FIG. 16 is a diagram illustrating an operation of a PCIe device based on some implementations of the disclosed technology.

FIG. 17 is a diagram illustrating an operation of a PCIe device based on some implementations of the disclosed technology.

FIG. 18 illustrates an embodiment of a process for processing a read command in a PCIe system based on some implementations of the disclosed technology.

FIG. 19 illustrates an embodiment of a process for processing a write command in a PCIe system based on some implementations of the disclosed technology.

FIG. 20 illustrates an embodiment of a process for processing a read command in a PCIe system based on some implementations of the disclosed technology.

FIG. 21 illustrates an embodiment of a process for processing write command in a PCIe system based on some implementations of the disclosed technology.

FIG. 22 illustrates timers included in a PCIe device.

FIG. 23 is a diagram illustrating an operation of a PCIe device according to an embodiment of the disclosed technology.

FIG. 24 is a diagram illustrating a structure of a PCIe device and communication with a host based on an embodiment of the disclosed technology.

FIG. 25 is a diagram illustrating power management of the PCIe interface device described with reference to FIG. 24.

FIGS. 26A and 26B are flowcharts illustrating an operation of the PCIe device.

### DETAILED DESCRIPTION

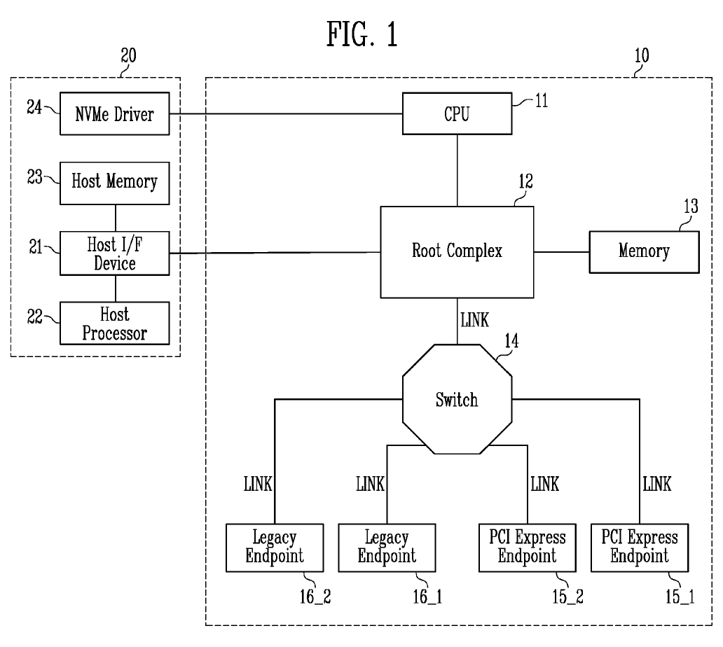

FIG. 1 is a block diagram illustrating a computing system.

Referring to FIG. 1, the computing system may include a peripheral component interconnect express (PCIe) system 10 and a host 20. The PCIe system 10 of FIG. 1 may include a central processing unit 11, a root complex 12, a memory 13, a switch 14, PCIe end points 15_1 and 15_2, and legacy end points 16_1 and 16_2. In one embodiment, the PCIe end point may referred to be as a PCIe device and the PCIe device may include a non-volatile memory express (NVMe) device. In addition, the host 20 of FIG. 1 may include a host interface (I/F) device 21, a host processor 22, a host memory 23, and an NVMe driver 24. In an embodiment, a storage device driver may include the NVMe driver.

In FIG. 1, the root complex 12 may be connected to the switch 14 through a link. In addition, the switch 14 may be corresponding to each of the PCIe end points 15_1 and 15_2 and the legacy end points 16_1 and 16_2 through the link. The link may be configured with at least one lane.

In an embodiment, the root complex 12 may connect the central processing unit 11 and the memory 13 to an I/O hierarchy. The root complex 12 may support a PCIe port. Thus, the root complex 12 may support a root port that may be connected to an input/output (I/O) device.

Additionally, the root complex 12 may support routing between hierarches of each configuration included in the PCIe interface device 100. The routing may include an operation of selecting a path from a transmission side to a reception side in data communication. The routing may be performed based on any one of a method of setting the path from the transmission side to the reception side in advance or selecting the most efficient path according to a state of a system or a network.

In some implementations, the root complex 12 may support an input/output request. The root complex 12 needs to support generation of a configuration request. It is not allowed for the root complex 12 to support lock semantics as a completer. The root complex 12 may request generation of a lock request as a requester.

In an embodiment, the root complex 12 may divide a packet transmitted between hierarches into smaller units during routing. In addition, the root complex 12 may generate the input/output request.

In an embodiment, the switch 14 may be configured with two or more logical PCI-to-PCI bridges. Each of the two or more logical PCI-to-PCI bridges may be connected to an upstream port or a downstream port.

The switch 14 may transmit a transaction using a PCI bridge mechanism (address-based multicasting method). At this time, the switch 14 needs to be capable of transmitting all types of transaction layer packets (TLPs) through the upstream port and the downstream port. In addition, the switch 14 needs to support a locked request. Each port of the enabled switch 14 must be capable of supporting flow control. When competition occurs in the same virtual channel, the switch 14 may arbitrate in a round robin or weighted round robin method.

In an embodiment, differently from the root complex 12, the switch 14 may not divide the packet transmitted between the hierarches into smaller units.

In an embodiment, the PCIe end points 15_1 and 15_2 and the legacy end points 16_1 and 16_2 may serve as the requester or the completer of a PCIe transaction. The TLP transmitted and received by the PCIe end points 15_1 and 15_2 and the legacy end points 16_1 and 16_2 must provide a configuration space header. In addition, the PCIe end points 15_1 and 15_2 and the legacy end points 16_1 and 16_2 must provide a configuration request as the completer.

In an embodiment, the PCIe end points 15_1 and 15_2 and the legacy end points 16_1 and 16_2 may be distinguished according to a size of a memory transaction. For example, when a memory transaction exceeding 4 GB is possible, an end point may be the PCIe end points 15_1 and 15_2, and when a memory transaction exceeding 4 GB is impossible, the end point may be the legacy end points 16_1 and 16_2. The PCIe end points 15_1 and 15_2 must not generate the input/output request, but the legacy end points 16_1 and 16_2 may provide or generate the input/output request.

In an embodiment, the PCIe end points 15_1 and 15_2 or the legacy end points 16_1 and 16_2 may transmit and receive the TLP to and from the switch 14.

In an embodiment, the switch 14 may transmit the TLP received from the PCIe end points 15_1 and 15_2 or the legacy end points 16_1 and 16_2 to the root complex 12.

In an embodiment, the root complex 12 may transmit and receive the TLP to and from the PCIe end points 15_1 and 15_2 or the legacy end points 16_1 and 16_2 through the switch 14. The root complex 12 may transmit the TLP received from the PCIe end points 15_1 and 15_2 or the legacy end points 16_1 and 16_2 to the central processing unit 11 or the memory 13.

In an embodiment, the host processor 22 and the host memory 23 included in the host 20 may be connected to the root complex 12 through the host I/F device 21.

In an embodiment, the host processor 22 may control a write operation or a read operation to be performed on a a peripheral component interconnect express (PCIe) device corresponding to each of the PCIe end points 15_1 and 15_2 or the legacy end points 16_1 and 16_2. In some implementations, the PCIe device may be or include a solid state drive (SSD). The SSD may include a NVMe(Non Volatile Memory Express) controller and a NVMe device. In addition, the host processor 22 may store information necessary for controlling the write operation or the read operation to be performed on the PCIe device in the host memory 23.

In an embodiment, the NVMe driver 24 may be connected to the central processing unit 11 and allow the host 20 to control the PCIe device through the PCIe interface device 100.

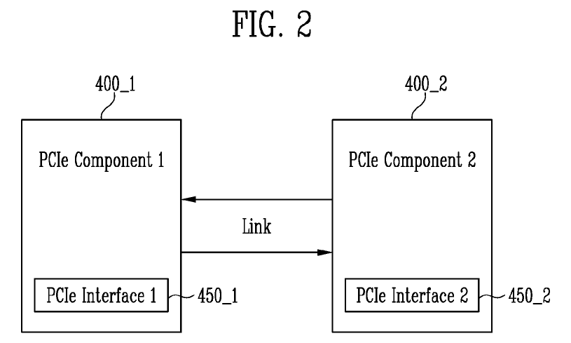

FIG. 2 is a diagram illustrating PCIe components based on an embodiment of the disclosed technology.

Referring to FIGS. 1 and 2, the PCI components 450_1 and 450_2 may be any one of the root complex 12, the switch 14, the PCIe end points 15_1 and 15_2, and the legacy end points 16_1 and 16_2 of FIG. 1. The PCI components 450_1 and 450_2 may be any one of components connected by the link. The link may be configured with at least one lane.

In an embodiment, the PCI components PCI 450_1 and 450_2 may transmit and receive a packet through the link. Each of the PCI components 450_1 and 450_22 may operate as a transmitter (TX) transmitting the packet or a receiver (RX) receiving the packet.

In an embodiment, the packet may be an information transmission unit that includes a selective TLP prefix, a header, and a data payload.

In an embodiment, a packet that does not need to be cached is not snooped, thereby reducing latency. When dependence does not exist between transactions, operation performance of the packet can be improved by changing ordering. In addition, operation performance of the packet can be improved by changing the ordering based on an ID.

Referring to FIG. 2, a first PCIe component 400_1 may include a first PCIe interface device 450_1. A second PCIe component 400_2 may include a second PCIe interface device 450_2.

The first PCIe component 400_1 and the second PCIe component 400_2 may be an electronic device supporting communication using a PCIe protocol. For example, the first PCIe component 400_1 may be a PC, a laptop computer, or a mobile computing device. In addition, the second PCIe component 400_2 may include an expansion card, an expansion board, an adapter card, an add-in card, or an accessory card. The second PCIe component 400_2 may include a printed circuit board (PCB) that may be inserted into an electrical connector or an expansion slot on a motherboard of the first PCIe component 400_1 in order to provide an additional function to the first PCIe component 400_1 through an expansion bus. The second PCIe component 400_2 may include a storage device such as a solid state drive (SSD), a graphic card, a network card, or a USB card. In another embodiment, the first PCIe component 400_1 and the second PCIe component 400_2 may be reversely configured.

The first PCIe component 400_1 and the second PCIe component 400_2 may perform communication using the first PCIe interface device 450_1 and the second PCIe interface device 450_2, respectively. The first PCIe component 400_1 and the second PCIe component 400_2 may form a link and communicate through the formed link. The first PCIe component 400_1 and the second PCIe component 400_2 may transmit and receive a data packet with each other through the link.

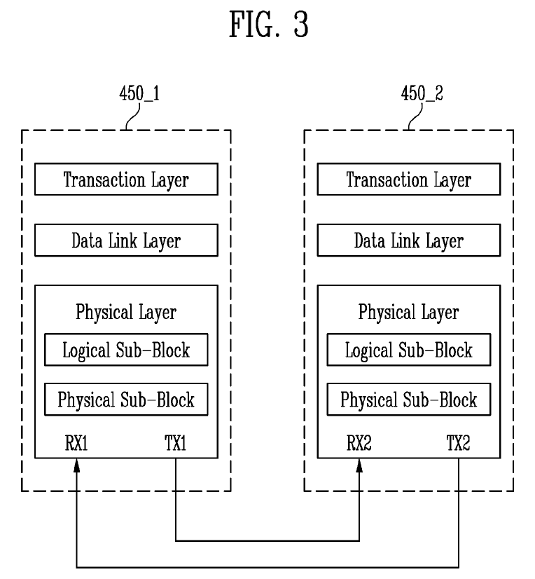

FIG. 3 is a diagram illustrating layers included in the PCIe interface device described with reference to FIG. 2.

Referring to FIGS. 2 and 3, each of the PCI interface devices 450_1 and 450_2 may include a transaction layer, a data link layer, and a physical layer. The physical layer may include a logical sub block and a physical sub block.

The transaction layer may combine or disassemble a transaction layer packet (TLP). Here, the TLP may be used to process a transaction of read and write, that is, a specific event.

The transaction layer may control a credit-based flow. In addition, the transaction layer may support addressing of various formats according to a transaction type. For example, the transaction layer may support addressing for a memory, input/output, a configuration, or a message.

The transaction layer may perform initialization and configuration functions. Specifically, the transaction layer may store link setting information generated by a processor or a management device. In addition, the transaction layer may store a link property related to a bandwidth and a frequency determined in the physical layer.

The transaction layer may generate and process a packet. Specifically, the TLP requested from a device core may be generate and the received TLP may be converted into data payload or state information. In addition, when the transaction layer supports end-to-end data integrity, transaction layer may generate a cyclic redundancy code (CRC) and update the CRC to a header of the TLP.

The transaction layer may perform flow control. Specifically, the transaction layer may track a flow control credit for the TLP in the link. In addition, the transaction layer may periodically receive a transaction credit state through the data link layer. The transaction layer may control TLP transmission based on flow control information.

The transaction layer may manage power. Specifically, the transaction layer may manage power according to an instruction of a system software. In addition, the transaction layer may perform autonomous power management according to an instruction of hardware in a state in which the power is turned on.

The transaction layer may identify a virtual channel mechanism and a traffic class for a specific class of an application. The transaction layer may provide an independent logical data flow through a specific physical resource. In addition, the transaction layer may apply an appropriate service policy in a method of providing different ordering through packet labeling.

The data link layer may be responsible for link management, data integrity, error detection, and error correction. The data link layer may transmit the TLP, which is to be transmitted, to the physical layer, by assigning a data protection code and a TLP sequence number. In addition, the data link layer may check the integrity of the TLP received from the physical layer and transmit the TLP to the transaction layer.

When the data link layer detects an error of the TLP, the data link layer may receive a TLP in which an error does not exist or request the physical layer to retransmit the TLP until it is determined that the link is in a fail state. The data link layer may generate and consume a data link layer packet (DLLP) used for the link management.

The data link layer may exchange reliable information. In addition, the data link layer may manage initialization and power. Specifically, the data link layer may transmit a power state request of the transaction layer to the physical layer. In addition, the data link layer may transmit information on activation-or-not, reset, connection release, and power management state to the transaction layer.

The data link layer may perform data protection, error checking, and retry. Specifically, the data link layer may generate the CRC for data protection. In addition, the data link layer may store the TLP to enable retry on the transmitted TLP. The data link layer may check the TLP, transmit a retry message, report an error, and display an error for logging.

The physical layer may include a driver, an input buffer, a parallel-to-serial or serial-to-parallel converter, and a configuration for an interface operation such as a phase locked loop (PLL).

The physical layer may convert a packet received from the data link layer into a serialized format and transmit the packet. In addition, the physical layer may set the bandwidth and frequency according to compatibility with a device connected to another side of the link. In order to communicate data serially, the physical layer may convert the packet from parallel to serial and from serial to parallel again. That is, the physical layer may perform a function of a serializer or deserializer.

The physical layer may perform interface initialization, maintenance and state tracking. Specifically, the physical layer may manage power by connection between components. In addition, the physical layer may negotiate a bandwidth and lane mapping between the components and reverse a polarity of a lane.

The physical layer may generate a symbol and a special ordered set. In addition, the physical layer may transmit and align the generated symbol.

The physical layer may serve as a packet transmitter or receiver between PCI components. The physical layer may convert the packet received through the transaction layer and the data link layer and transmit the packet to another PCI component, and convert the packet received from another PCI component and transmit the packet to the transaction layer through the data link layer.

The logical sub block included in the physical layer may be configured of two sections. One of the two sections may be a transmission section for preparing of a transmission, to the physical sub layer, of information that has been transmitted from the data link layer. The other of the two sections may be a receiving section for identifying information and preparing an output of the information to the data link layer. Thus, the receiving section identifies information and outputs the identified information to the data link layer.

The physical sub block included in the physical layer may be an electrical sub block, and may support a commonly or individually independent reference clock structure. In addition, the physical sub block may reduce swing for a low power link operation, detect a receiver in a band, and detect an electrical idle state.

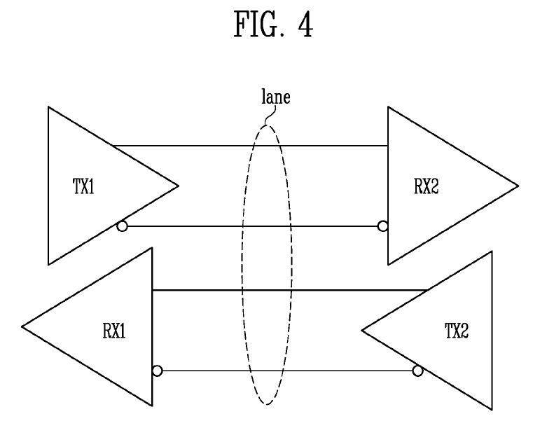

FIG. 4 is a diagram illustrating a lane according to an embodiment of the disclosed technology.

Referring to FIG. 4, a first transmitter TX1, a second transmitter TX2, a first receiver RX1, and a second receiver RX2 are shown to be on two sides of the lane: the first side includes the first transmitter TX1 and the first receiver RX1, and a second side includes the second transmitter TX2 and second receiver RX2. This lane provides communications between the two sides in two opposite directions: from TX1 to RX2 in one direction and from TX2 to RX1 in the opposite direction. The lane may include a path including differentially driven signal pairs, for example, a transmission path pair configured for transmission and a reception path pair configured for reception. The PCIe component may include a transmission logic that transmits data to another PCIe component, and a reception logic that receives data from another PCIe component. For example, the PCIe component may include two transmission paths connected to the first transmitter TX1 and two reception paths connected to the first receiver RX1.

The transmission path may be used for transmitting data and configured to include a transmission line, a copper line, an optical line, a wireless communication channel, an infrared communication link, or any other communication path. The reception path may be used for receiving data and configured to include a reception line, a copper line, an optical line, a wireless communication channel, an infrared communication link, or any other communication paths.

A connection between the first PCIe component 400_1 and the second PCIe component 400_2 described with reference to FIG. 2 may be referred to as a link. The link may support at least one lane. In some implementations, each lane may indicate a set of differential signal pairs (one pair for transmission and the other pair for reception). The link may include a plurality of lanes to adjust the bandwidth. For example, the link may include 1, 2, 4, 8, 12, 16, 32, 64, or others.

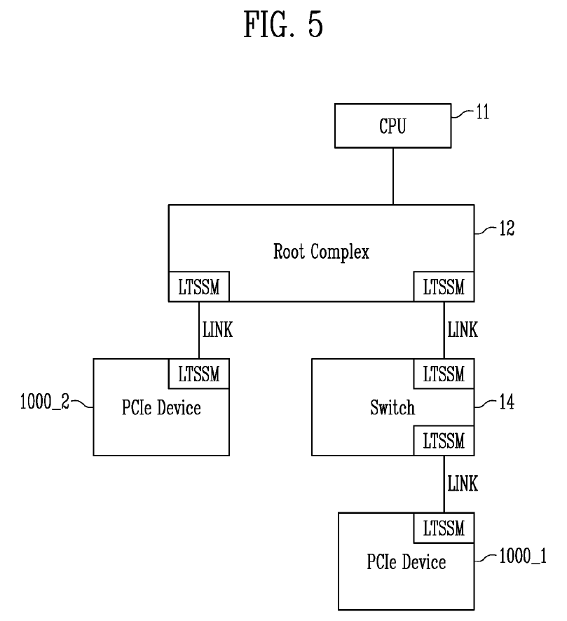

FIG. 5 is a diagram illustrating a link training & status state machine (LTSSM).

Referring to FIGS. 1 and 5, FIG. 4 shows the central processing unit (CPU) 11, the root complex 12, the switch 14, and PCIe devices 1000_1 and 1000_2. Each component of FIG. 4 may include the LTSSM. The LTSSM may exchange Training Sequences (ex. TS1 and TS2) to negotiate a number of link parameters, such as a polarity of the lane configuring the link connecting each component, the number of links or lanes, equalization, and data transmission speed.

In an embodiment, the LTSSM may be a hardware-based processor controlled by the physical layers in a PCIe component. For a normal operation, the LTSSM may establish and initialize the link and a port between each component to enable packet transmission. The link may have any one of 11 states such as Detect and Polling, and each state may have a sub state.

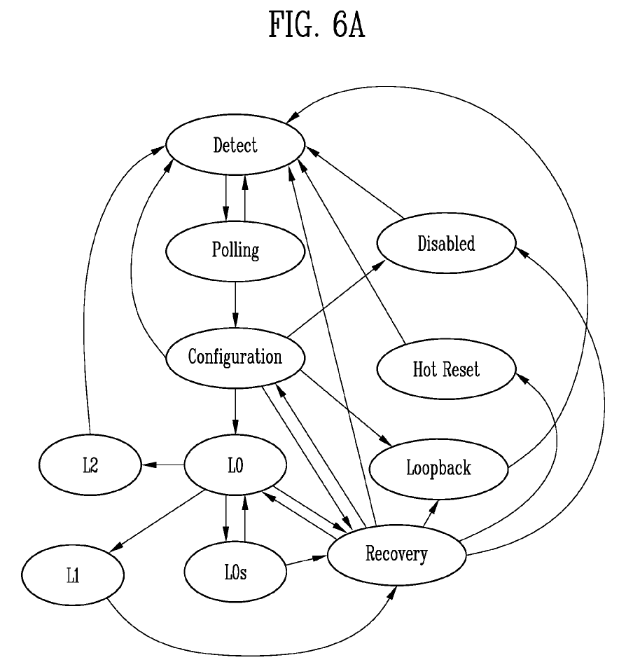

A flow between various states that the link may have is described in more detail with reference to FIGS. 6A and 6B.

In an embodiment, in order to configure the port for connecting each component, a separate LTSSM may be required for each individual link. For example, in order to configure a port for connecting the root complex 12 and the PCIe device 1000_2, each of the root complex 12 and the PCIe device 1000_2 may include the LTSSM. In addition, in order to configure a port for connecting the root complex 12 and the switch 14, each of the root complex 12 and the switch 14 may include the LTSSM. Furthermore, in order to configure a port for connecting the switch 14 and the PCIe device 1000_1, each of the switch 14 and the PCIe device 1000_1 may include the LTSSM.

In an embodiment, among ports of the switch 14, a port close to the root complex 12 may be an upstream port, and a port far from the root complex 12 may be a downstream port. The upstream port and the downstream port may synchronize an LTSSM transition by exchanging the Training Sequences (ex. TS1 and TS2) with the root complex 12 and the PCIe device 1000_1, respectively. At this time, in synchronizing the LTSSM transition, the upstream port and the downstream port may be independent of each other and may or may not be influenced by each other.

In an embodiment, the central processing unit 11 may not be affected by the LTSSM between each component. Therefore, in a case of a link down that is not intended by the host, a problem such as a blue screen may occur.

FIG. 6A is a diagram illustrating a link training & status state machine (LTSSM) in relation to the link described with reference to FIG. 5.

A detect state may be a state in which the link connected between the PCIe components is detected. In the detect state, a physically connected lane is searched for.

The detect state may be an initial state of the LTSSM, and may be a state that is entered after reset or when booting. In addition, the detect state may reset all logic, ports and registers. The detect state may be entered when instructed from the host. The LTSSM may proceed from the detect state to a polling state.

In an embodiment, the polling state may be a state in which a lane capable of data communication is distinguished from among detected lanes. That is, the polling state may be a state in which clocks between the PCIe components are synchronized, a polarity of the lane is checked (whether it is D+ or D-), and a data transmission speed that the lane may use is checked. Furthermore, the polling state may be a state in which a boundary between consecutive bits in data is checked. In an embodiment, the LTSSM may proceed from the polling state to a configuration state.

In an embodiment, the configuration state may be a state in which a connection state of the lane is checked. For example, the configuration state may be a state in which a lane width in which data communication is possible is determined. In addition, in the configuration state, a bit indicated as PAD of Training Sequences is changed to the negotiated number, and negotiation for maximum performance between both components may be performed. In the configuration state, both of the transmitter and the receiver may transmit or receive data at negotiated data transmission/reception speed. In addition, in the configuration state, lane to lane de-skew, in which parallel bit streams reach at different devices at different times from a plurality of lanes.

In an embodiment, the LTSSM may proceed from the configuration state to the detect state, an L0 state, a recovery state, a loopback state, or a disabled state.

In an embodiment, the L0 state may be a state in which data and a control packet are normally transmitted and received. In the L0 state, a transaction layer packet (TLP) and a data link layer packet (DLLP) may be transmitted and received. In addition, all power management states may be started from the L0 state.

In an embodiment, the LTSSM may proceed from the L0 state to an L1 state, an L2 state, an L0s state, or the recovery state.

In an embodiment, each of the L0s state, the L1 state, and the L2 state may correspond to a low power state.

In some implementation, the L0s state may be a sub state of the L0 state, and in the L0s state, the link may quickly proceed to the low power state and recover without passing through the recovery state. In addition, in order to proceed from the L0s state to the L0 state, bit lock, symbol lock, and lane to lane de-skew may be reset. At this time, the transmitter and the receiver of both components are required to in the L0s state simultaneously. The LTSSM may proceed from the L0s state to the L0 state or the recovery state.

A return speed of the L1 state to return to the L0 state is slower than that of the L0s state, but the L1 state allows additional power saving more than the L0 state through an additional resumption latency in the L1 state. The L1 state may be entered through active state power management (ASPM) or power management software. At this time, the ASPM may be a policy to change the link to a low power state when a device connected to the PCIe is not used, and the power management software may be a policy to change the device connected to the PCIe to the low power state.

In addition, the entry into the L1 state may proceed after receiving an electrical idle ordered set (EIOS) according to an instruction received from the data link layer. The LTSSM may proceed from the L1 state to the recovery state.

In the L2 state, maximum power is conserved, and the transmitter and the receiver of the device connected to the PCIe may be shut off. In the L2 state, power and clock may not be guaranteed, but AUX power may be used. The entry into the L2 state may proceed after receiving the EIOS according to the instruction from the data link layer. The LTSSM may proceed from the L2 state to the detect state.

In an embodiment, the recovery state may be entered when an error occurs in the L0 state, and transit to the L0 state again after the error recovery. In some implementations, the recovery state may enter upon returning from the L1 state to the L0 state. In some implementations, the recovery state may correspond to a transition state when entering the loopback state, a hot reset state, or a disabled state.

In the recovery state, bit lock, symbol lock, or block alignment and lane to lane de-skew may be reset. In addition, in the recovery state, a data transmission speed of the lane may be changed.

In an embodiment, the LTSSM may proceed from the recovery state to the L0 state, the configuration state, the detect state, the loopback state, the hot reset state, or the disabled state.

In an embodiment, the loopback state may proceed for a test, and may be entered when measuring a bit error rate. The loopback may be a state in which bit 2 is used in a training control field of training sequences (ex. TS1 and TS2), and the receiver may retransmit all received packets. The LTSSM may proceed to the detect state after measuring the bit error rate in the loopback state.

In an embodiment, the hot reset state may be a state in which the link is reset, and may be a state in which bit 0 is used in the training control field of the training sequences (ex. TS1 and TS2). The LTSSM may proceed from the hot reset state to the detect state.

In an embodiment, the disabled state may be a state in which the transmitter is in an electrical idle state when the receiver is in a low impedance state. In the disabled state, the link may be deactivated until the electrical idle state ends. The disabled state may be a state in which bit 1 is used in the training control field of the training sequences (ex. TS1 and TS2). When an instruction from a higher state, the LTSSM may proceed to the disabled state. The LTSSM may proceed from the disabled state to the detect state.

A link up may indicate transition from the detect state to the L0 state through the polling state and the configuration state, and a link down may indicate transition to the detect state again. A link training may indicate a state in which the physical layer among the PCIe layers is in the configuration state or the recovery state.

In addition, the LTSSM may set a link up register value for each state. For example, a state in which the link up register is ‘1’ may be a link up state, and a state in which the link up register is ‘0’ may be a link down state. When the LTSSM initially proceeds to the L0 state, the link up register may be set to ‘1’.

Specifically, the link up register corresponding to the detect state, the polling state, the configuration state, the loopback state, the hot reset state, and the disabled state may be set to ‘0’, and the link up register corresponding to the L0 state, the L0s state, the L1 state, and the L2 state may be set to ‘1’.

In an embodiment, during the link down, data may be flushed, and a PCIe register and an NVMe register may be reset. Therefore, the host is required to initialize the PCIe register and the NVMe register. In a case of the link down intended to the host, the host may initialize PCIe register and NVMe register.

In a case of a sudden link down that is not intended to the host, for example, in a case of failure of data transmission/reception speed change, failure of lane change, failure of low power end, or others, the LTSSM timeout may occur, and thus the LTSSM may transit to the detect state. At this time, since the sudden link down that is not intended to the host is the link down between two ports, an OS and an NVMe driver may not be aware of this. Therefore, the host may attempt to access a device without initializing the PCIe register and the NVMe register, which causes undesired occurrence such as a blue screen and/or a stop of a host operation due to reset values.

In an embodiment, the L0 state may be referred to as a normal link state in which a link operates normally as compared to the L1 state, the L2 state, L0s state. In some implementations, the L1 state may be referred to as a low power link state. In one embodiment, in the L0 state, the power of the link may be a normal state, and in the L1 state, the power of the link may be a low power state.

FIG. 6B is a diagram illustrating sub states of L1 described with reference to FIG. 6A.

Referring to FIG. 6B, the sub state of L1 may include an L1.0 sub state, an L1.1 sub state, and an L1.2 sub state.

The L1.0 sub state may transit to the L1.1 sub state or the L1.2 sub state. In one embodiment, in the L1.1 sub state or the L1.2 sub state, the power of the link may be an ultra-low power state.

The L1.0 sub state may correspond to the L1 state described with reference to FIG. 3. In order to detect an electrical idle exit in the L1.0 sub state, an upstream port and a downstream port are required to be activated.

The L1.1 sub state may transit to the L1.0 sub state.

In the L1.1 sub state, link common mode voltages are required to be maintained. In order to enter into or exit from the L1.1 sub state, a bidirectional open-drain clock request (CLKREQ#) signal may be used. In order to detect the electrical idle exit in the L1.1 sub state, the upstream port and the downstream port are not required to be activated.

The L1.2 sub state may transit to the L1.0 sub state.

In the L1.2 sub state, the link common mode voltages are not required to be maintained. In order to enter into or exit from the L1.2 sub state, a bidirectional open-drain clock request (CLKREQ#) signal may be used. In order to detect the electrical idle exit in the L1.1 sub state, the upstream port and the downstream port are not required to be activated.

A reference clock may not be required for a port that supports the sub states (the L1.1 sub state and the L1.2 sub state) of L1 except for the L1.0 sub state. The open-drain clock request (CLKREQ#) signal may be used by a sub state protocol of L1, but a relationship with a local clock used in the port of the link may not be defined separately. The port supporting the L1.2 sub state is required to support latency tolerance reporting (LTR).

In an embodiment, the L1.1 sub state and the L1.2 sub state may be a low power link sub state.

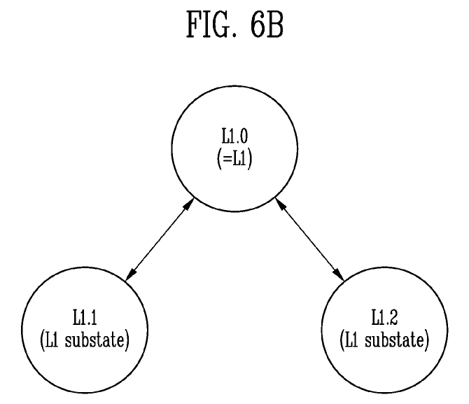

FIG. 7 is a diagram illustrating a command process in a PCIe device.

Referring to FIGS. 1 and 7, FIG. 7 shows a process in which the command is executed on the PCIe device. The PCIe device may any one of the PCIe end points 15_1 and 15_2 or the legacy end points 16_1 and 16_2 The PCIe device may include an NVMe controller 50. In FIG. 7, the host memory 23 may include a SUBMISSION QUEUE (SQ) and a COMPLETION QUEUE (CQ).

In an embodiment, the NVMe driver for controlling the PCIE device may a component included in the host 20. The NVMe driver 24 may transmit the command to be executed on the PCIe device to the SUBMISSION QUEUE. The SUBMISSION QUEUE may queue the command received from the NVMe driver 24. For example, the host memory 23 may sequentially queue the received command from HEAD to TAIL of the SUBMISSION QUEUE.

When the command is queued in the SUBMISSION QUEUE, the NVMe driver 24 may output a SUBMISSION QUEUE TAIL DOORBELL signal to the NVMe controller 50. The NVMe controller 50 may receive the SUBMISSION QUEUE TAIL DOORBELL signal and store SUBMISSION QUEUE TAIL ENTRY POINTER in a register. Here, the SUBMISSION QUEUE TAIL ENTRY POINTER may be an indicator indicating the command queued in a TAIL portion of the SUBMISSION QUEUE among the commands queued in the SUBMISSION QUEUE. The NVMe controller 50 may store SUBMISSION QUEUE TAIL ENTRY POINTER in the register to identify a new command output from the host memory 23.

Thereafter, the NVMe controller 50 may fetch the command from the host memory 23. The NVMe controller 50 may receive the commands queued in the SUBMISSION QUEUE. The NVMe controller 50 may perform an operation corresponding to the received commands.

In an embodiment, after the NVMe controller 50 performs the operation corresponding to the commands, COMPLETION QUEUE ENTRY may be transmitted to the host memory 23. The COMPLETION QUEUE ENTRY may include information on the most recently executed command by the NVMe controller 50. The host memory 23 may queue the received COMPLETION QUEUE ENTRY in the COMPLETION QUEUE. For example, the host memory 23 may sequentially queue the received COMPLETION QUEUE ENTRY from the HEAD to the TAIL of the COMPLETION QUEUE.

Thereafter, the NVMe controller 50 may output an INTERRUPT signal to the NVMe driver 24. The INTERRUPT signal may be a signal indicating that the COMPLETION QUEUE ENTRY has been queued in the COMPLETION QUEUE.

When receiving the INTERRUPT signal, the NVMe driver 24 may perform an operation based on the COMPLETION QUEUE ENTRY of the COMPLETION QUEUE. When the NVMe driver 24 completes the operation, the NVMe driver 24 may output a COMPLETION QUEUE HEAD DOORBELL signal to the NVMe controller 50. The NVMe controller 50 may receive the COMPLETION QUEUE HEAD DOORBELL signal and store the COMPLETION QUEUE HEAD ENTRY POINTER in the register. Here, the COMPLETION QUEUE HEAD ENTRY POINTER may be an indicator indicating an entry queued in a HEAD portion of the COMPLETION QUEUE among entries queued in the COMPLETION QUEUE. The NVMe controller 50 may store the COMPLETION QUEUE HEAD ENTRY POINTER in the register in order to identify the command whose corresponding operation has been completed.

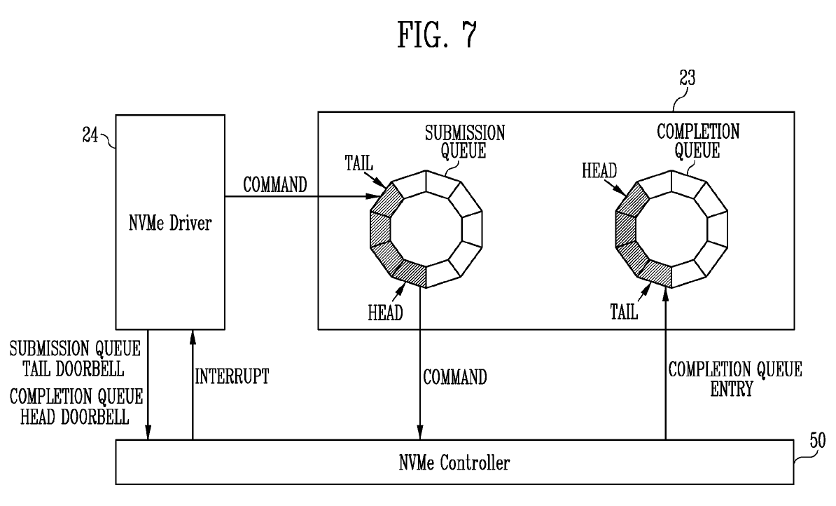

FIG. 8 is a diagram illustrating the the command process of FIG. 7.

FIG. 8 shows operations of the NVMe driver 24, the host memory 23, and the PCIe device. The PCIe device may correspond to one of the PCIe end points 15_1 and 15_2 or the legacy end points 16_1 and 16_2 of FIG. 1.

In FIG. 8, a non-DMA (direct access memory) operation may refer to an operation performed by the central processing unit 11 of FIG. 1, and a DMA (direct access memory) operation may refer to an operation performed independently without intervention of the central processing unit 11 of FIG. 1.

In an embodiment, the NVMe driver 24 outputs the command to be executed on the PCIe device to the host memory 23, and the host memory 23 may sequentially queue the received command from the HEAD to the TAIL of the SUBMISSION QUEUE.

Thereafter, the NVMe driver 24 may output the SQ DOORBELL signal to the PCIe device. The SQ DOORBELL signal may be the same signal as the SUBMISSION QUEUE TAIL DOORBELL signal of FIG. 7. That is, the NVMe driver 24 may output the SQ DOORBELL signal to the PCIe device so that a new command output from the host memory 23 is identified.

In an embodiment, the PCIe device may fetch the command from the host memory 23. That is, the PCIe device may receive the commands queued in the SUBMISSION QUEUE from the host memory 23 and perform operations corresponding to the received commands. When the PCIe device completes the operations corresponding to the commands received from the host memory 23, the PCIe device may output a COMPLETION signal to the host memory 23.

Thereafter, the NVMe driver 24 and the PCIe device may perform the DMA operation independently performed without intervention of the central processing unit 11 of FIG. 1.

In an embodiment, after the PCIe device performs the operation corresponding to the commands, COMPLETION QUEUE of the host memory 23 may be updated (CQ UPDATE). That is, after the PCIe device performs the operation corresponding to the commands, COMPLETION QUEUE ENTRY may be transmitted to the host memory 23, and the host memory 23 may sequentially queue the received COMPLETION QUEUE ENTRY from the HEAD to the TAIL of the COMPLETION QUEUE.

Thereafter, the PCIe device may output the INTERRUPT signal to the NVMe driver 24. The INTERRUPT signal may be a signal indicating that the COMPLETION QUEUE ENTRY is queued in the COMPLETION QUEUE.

In an embodiment, when the operation performed by the NVMe driver 24 based on the COMPLETION QUEUE ENTRY of the COMPLETION QUEUE is completed, the NVMe driver 24 may output a CQ DOORBELL signal to the PCIe device. The CQ DOORBELL signal may be the same signal as the COMPLETION QUEUE HEAD DOORBELL signal of FIG. 7. That is, the NVMe driver 24 may output the CQ DOORBELL signal to the PCIe device so that the command of which the operation is completed is identified.

Thereafter, the NVMe driver 24 may output a new command to be executed on the PCIe device to the host memory 23, and output the SQ DOORBELL signal to the PCIe device so that the new command output from the host memory 23 is identified.

Among the operations described above, operations except for the DMA operation may be the non-DMA operation. Referring to FIG. 8, it is noted that more non-DMA operation is performed than the DMA operation. Since it takes more time to process the non-DMA operation, there is a need for an implementation that can reduce the time to process the non-DMA operation. In order to reduce the time consumed for the non-DMA operation, a method of performing the non-DMA operation through a lightweight notification (LN) will be discussed below.

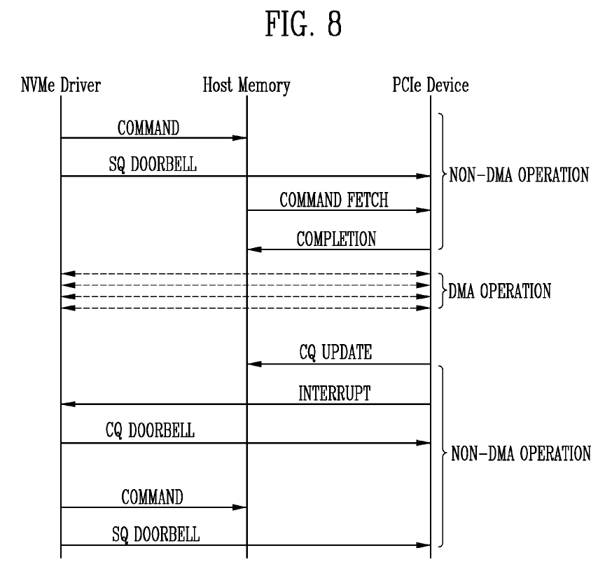

FIG. 9 is a diagram illustrating a command process performed through a LN.

FIG. 9 shows operations of the NVMe driver 24, the host memory 23, and the PCIe device of FIG. 8 based on a PCIe lightweight notification (LN). The LN may indicate a specific address of the host memory 23 and may be included in a header of a transaction layer packet (TLP). In addition, the LN may be registered in a cache line of the root complex 12 of FIG. 1.

In FIG. 9, the non-DMA operation refers to the operation performed by the central processing unit 11 of FIG. 1, and the DMA operation may refer to the operation independently performed without intervention of the central processing unit 11 of FIG. 1.

In an embodiment, the PCIe device may register the LN in the host memory 23 and the cache line of the root complex 12 of FIG. 1. At this time, the LN may indicate a position at which the command is queued in the host memory 23.

When the LN is registered in the host memory 23 and the cache line of the root complex 12 of FIG. 1, the NVMe driver 24 may output the command to be executed on the PCIe device to the host memory 23, and the host memory 23 may sequentially queue the received command from the HEAD to the TAIL of the SUBMISSION QUEUE.

In an embodiment, when the command is queued in the host memory 23, the host memory 23 may output an LN message to the PCIe device. The LN message may indicate a position in which the command is queued in the host memory 23. The host memory 23 may output a changed position to the PCIe device through the LN message when the position in which the command is queued is changed.

In an embodiment, the PCIe device may pre-fetch the command (COMMAND PRE-FETCH). For example, the PCIe device may receive the commands queued in the SUBMISSION QUEUE from the host memory 23. The command queued in the SUBMISSION QUEUE may be updated before the NVMe driver 24 outputs the SQ DOORBELL signal, and the host memory 23 may output the LN message to the PCIe device before the SQ DOORBELL signal is output. Thus, the PCIe device can prepare an execution of the command in advance through the pre-fetch of the command. Furthermore, since command information is stored in the cache line of the root complex 12 of FIG. 1, the command can be quickly fetched to increase an operation speed of the PCIe device.

Thereafter, the NVMe driver 24 may output the SQ DOORBELL signal to the PCIe device. The SQ DOORBELL signal may be the same signal as the SUBMISSION QUEUE TAIL DOORBELL signal of FIG. 7. The NVMe driver 24 may output the SQ DOORBELL signal to the PCIe device so that the new command output from the host memory 23 is identified. The PCIe device may perform an operation corresponding to the pre-fetched command based on the SQ DOORBELL signal.

After receiving the SQ DOORBELL signal, the PCIe device may fetch the command from the host memory 23 (COMMAND FETCH). When the PCIe device fetches the command, the LN registration may be released. The PCIe device may perform an operation based on a result of comparing the pre-fetched command and the fetched command.

For example, when the pre-fetched command and the fetched command are the same, the PCIe device may continuously perform the operation corresponding to the pre-fetched command. However, when the pre-fetched command and the fetched command are different, the PCIe device may stop the operation corresponding to the pre-fetched command and perform an operation corresponding to the fetched command.

When the PCIe device completes the operations corresponding to the commands received from the host memory 23, the PCIe device may output the COMPLETION signal to the host memory 23.

In an embodiment, the operation of fetching the command from the host memory 23 and the operation of outputting the COMPLETION signal to the host memory 23 by the PCIe device may be the non-DMA operation performed through the central processing unit 11 of FIG. 1. Since the above non-DMA operations are operations performed between the DMA operations, data input/output random performance can be improved. The input/output random performance may mean random performance of data of a specific size per command.

Thereafter, the PCIe device may register the LN indicating the position at which a next command is queued in the host memory 23 and the cache line of the root complex 12 of FIG. 1.

In an embodiment, after the PCIe device performs the operation corresponding to the commands, the COMPLETION QUEUE of the host memory 23 may be updated (CQ UPDATE). After the CQ UPDATE, the PCIe device may output the INTERRUPT signal indicating that the COMPLETION QUEUE ENTRY has been queued in the COMPLETION QUEUE to the NVMe driver 24. When the operation performed by the NVMe driver 24 based on the COMPLETION QUEUE ENTRY of the COMPLETION QUEUE in response to the INTERRUPT signal is completed, the NVMe driver 24 may output the CQ DOORBELL signal to the PCIe device.

In an embodiment, the NVMe driver 24 may further perform an operation of outputting the command to be performed on the PCIe device to the host memory 23.

As a result, by registering the LN in the host memory 23 and pre-fetching the command, a time to fetch the command can be shortened and the input/output random performance of the PCIe device can be improved.

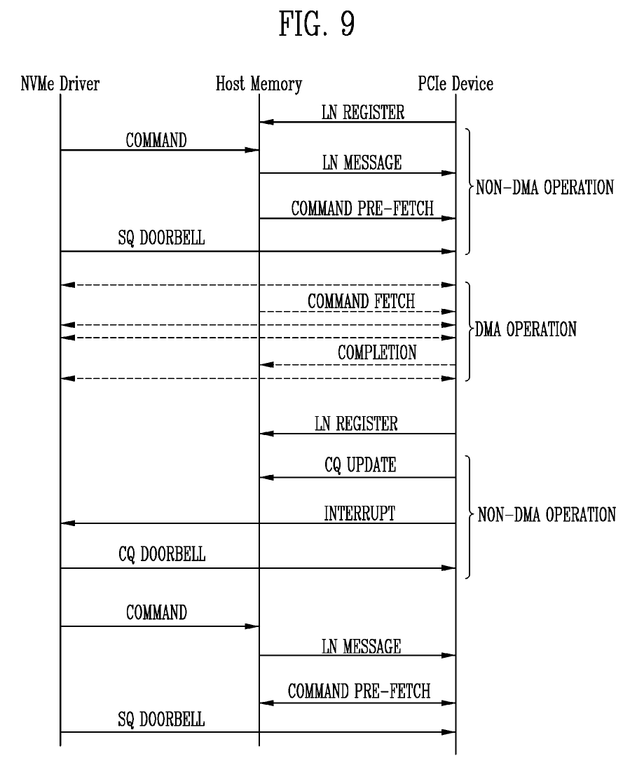

FIG. 10 is a diagram illustrating the LN.

FIG. 10 shows a portion of a TLP header.

In an embodiment, the TLP header may include 0 to 3BYTE, and each BYTE may include 0 to 8BIT. Various information may be included in 0 to 3BYTE of the TLP header.

In an embodiment, 0BYTE of the TLP header may include FMT information indicating a TLP format and TYPE information indicating a type of the TLP. For example, the FMT information may be included in 7 to 5BIT of 0BYTE, and the TYPE information may be included in 4 to 0BIT of 0BYTE.

In an embodiment, LN information may be included in 1BIT of 1BYTE of the TLP header. The LN may be a protocol that supports notification to an end point through a hardware mechanism when the cache line is updated. When 1BIT of 1BYTE is ‘1’, the LN information may indicate completion of the operation.

Referring to FIG. 9, before the NVMe driver 24 outputs the command to the host memory 23, the LN may be registered in the host memory 23. At this time, 1BIT of 1BYTE of the TLP header may be set to ‘1’. That is, before the NVMe driver 24 outputs the SQ DOORBELL signal to the PCIe device, the position at which the command is queued may be LN-registered, and when the PCIe device receives the LN message, the PCIe device may pre-fetch the command queued in the host memory 23.

Thereafter, when the NVMe driver 24 outputs the SQ DOORBELL signal to the PCIe device, when the PCIe device fetches the command again, 1BIT of 1BYTE of the TLP header may be set to ‘0’, and the LN registration may be released.

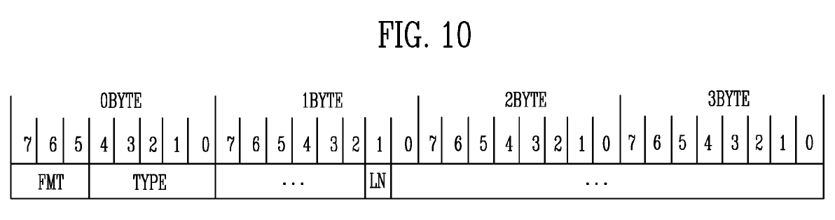

FIG. 11 is a diagram illustrating the LN registration.

FIG. 11 shows a host 20, a central processing unit 11, a root complex 12, a switch 14, and a PCIe device 1000. The PCIe device 1000 may be any one of the PCIe end points 15_1 and 15_2, and the legacy end points 16_1 and 16_2 of FIG. 1. In some implementations, the PCIe device 1000 may include a SSD.

In an embodiment, when the host 20 transmits the command to the PCIe device 1000, the host 20 may store the command information in the host memory 23 of FIG. 1, and then transmit the SQ DOORBELL signal to the PCIe device 1000. At this time, an address at which the command information is stored in the host memory 23 of FIG. 1 may be fixed. In some implementations of the disclosed technology, this address may be LN-registered in the host 20 and the cache line CACHE LINE of the root complex 12 of FIG. 1 (LN REGISTER).

In an embodiment, before the host 20 transmits the command to the PCIe device 1000, the LN may be registered. When the LN is registered, the host 20 may store the command information in the host memory 23 of FIG. 1 and output the LN message to the PCIe device 1000 simultaneously. Thus, the host 20 may notify the PCIe device 1000 that the command information is updated in the host memory 23 of FIG. 1 through the LN message. Thereafter, the host 20 may output the SQ DOORBELL signal to the PCIe device 1000.

As a result, by outputting the LN message before the host 20 outputs the SQ DOORBELL signal to the PCIe device 1000, the PCIe device 1000 can check an occurrence of the new command in advance.

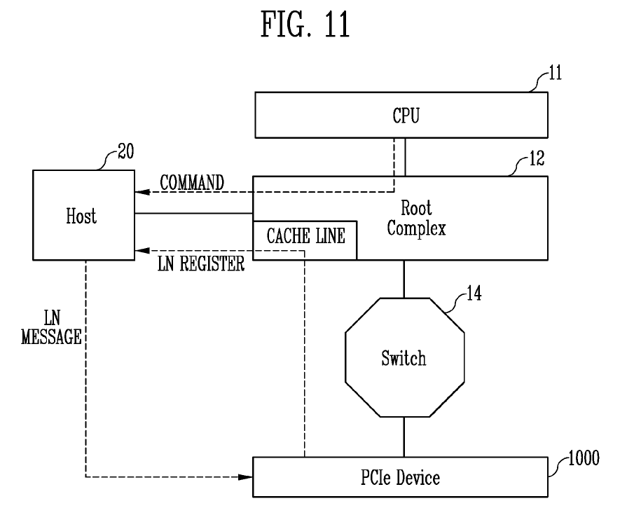

FIG. 12 is a diagram illustrating command pre-fetch and command fetch after the LN registration.

FIG. 12 shows an operation after the host 20 outputs the LN message to the PCIe device 1000 as discussed in FIG. 11.

In an embodiment, the PCIe device 1000 may pre-fetch the command stored in the host memory 23 of FIG. 1 before receiving the SQ DOORBELL signal. Specifically, the PCIe device 1000 may pre-fetch the command through the cache line CACHE LINE of the root complex 12 of FIG. 1. The PCIe device 1000 may check whether the new command is generated based on the LN message, and pre-fetch the command stored in the host memory 23 of FIG. 1 before receiving the SQ DOORBELL signal.

In an embodiment, by pre-fetching the command stored in the host memory 23 of FIG. 1, the time consumed to fetch the command may be reduced. Therefore, the input/output random performance may be improved. The input/output random performance may mean the random performance of data of a specific size per command.

In addition, in this case, after receiving the SQ DOORBELL signal, the PCIe device 1000 may fetch the command stored in the host memory 23 of FIG. 1 again (COMMAND FETCH).

In an embodiment, when the pre-fetched command and the fetched command are the same, the PCIe device 1000 may perform pre-fetching and continuously perform the operation corresponding to the command which is being executed. However, when the pre-fetched command and the fetched command are different, the PCIe device 1000 may stop the operation corresponding to the pre-fetched command and perform the operation corresponding to the newly fetched command.

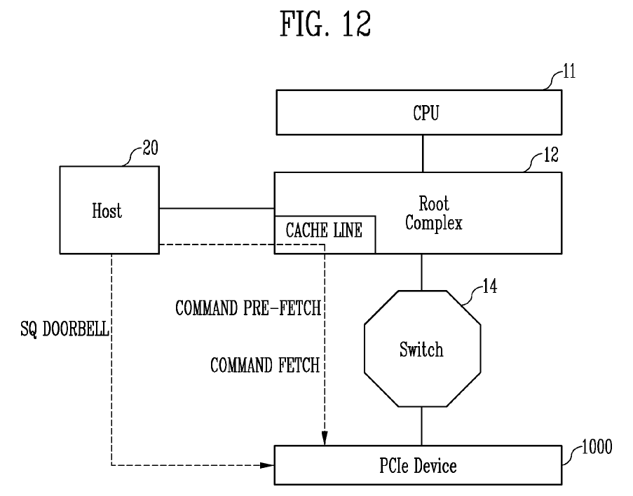

FIG. 13 is a diagram illustrating latency at an end of the low power state.

FIG. 13 shows operations of the NVMe driver 24, the host memory 23, which are shown in FIG. 7 The PCIe device may include SSD (Solid State Drive). The SSD may include a NVMe controller 50 and a NVMe device. The PCIe device is connected to the downstream port of the switch 14 of FIG. 1. The PCIe device may correspond to any one of the PCIe end points 15_1 and 15_2 or the legacy end points 16_1 and 16_2. Here, the downstream port may be a port that is located relatively further from the root complex 12 as compared to an upstream port of the switch 14.

In FIG. 13, the PCIe device may be in an L1.2 state. The L1.2 state may mean the low power state. In order to prevent power consumption, the PCIe device may be in the L1.2 state.

In FIG. 13, an L0 state may be a state in which power may be managed, and may be a state in which data and a control packet may be normally transmitted and received. For example, in the L0 state, a transaction layer packet (TLP) and a data link layer packet (DLLP) may be transmitted and received. The PCIe device may stop an operation in the L1.2 state and resume the operation in the L0 state.

In an embodiment, the NVMe driver 24 may output the command to be executed on the PCIe device to the host memory 23, and the host memory 23 may queue the received command. Thereafter, the NVMe driver 24 may output the SQ DOORBELL signal indicating that the new command is queued in the PCIe device through the downstream port.

However, since the PCIe device is initially in the L1.2 state, a wake up signal may be output to the PCIe device from the downstream port. According to the wake up signal, the PCIe device may be changed from the L1.2 state to the L0 state (LOW POWER EXIT), and the PCIe device may be in a state in which the operation may be performed again. At this time, latency LATENCY may occur until the state of the PCIe device is changed from the L1.2 state to the L0 state.

When the PCIe device is in a state in which the operation may be performed, the SQ DOORBELL signal received from the NVMe driver 24 may be output to the PCIe device from the downstream port.

Thereafter, in the L0 state, the PCIe device may fetch the command from the host memory 23. The PCIe device may receive the commands queued in the SUBMISSION QUEUE from the host memory 23 and perform the operations corresponding to the received commands.

In order to minimize an occurrence of the latency LATENCY until the state of the PCIe device is changed from the L1.2 state to the L0 state, some implementations of the disclosed technology suggest a method of ending the low power state by LN-registering the position in which the command is stored.

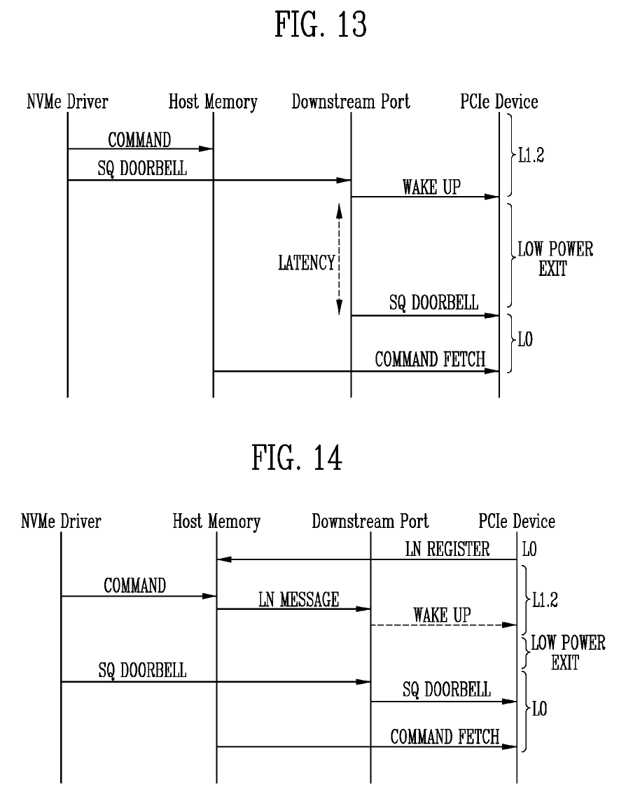

FIG. 14 is a diagram illustrating the end of the low power state through the LN registration.

FIG. 14 shows the operation of the NVMe driver 24 and the host memory 23, which are shown in FIG. 7, and a PCIe device. Here, the downstream port may be a port that is located relatively further from the root complex 12 as compared to an upstream port of the switch 14.

In FIG. 14, the PCIe device may be in an L1.2 state. The L1.2 state may mean the low power state. In order to prevent power consumption, the PCIe device may be in the L1.2 state.

In FIG. 14, an L0 state may be a state in which power may be managed, and may be a state in which data and a control packet may be normally transmitted and received. For example, in the L0 state, a transaction layer packet (TLP) and a data link layer packet (DLLP) may be transmitted and received. The PCIe device may stop an operation in the L1.2 state and resume the operation in the L0 state.

However, differently from FIG. 13, in FIG. 14, by registering the LN in the host memory 23, the state of the PCIe device can be changed from the L1.2 state to the L0 state.

In an embodiment, before the NVMe driver 24 transmits the command to the PCIe device 15, the LN can be registered in the host memory 23 in the L0 state (LN REGISTER). At this time, the LN may indicate an address in which the command information is stored in the host memory 23.

When LN is registered, in the L1.2 state, the NVMe driver 24 may store the command information in the host memory 23 and the LN message may be output from the host memory 23 to the downstream port simultaneously. Thus, the LN message for informing the downstream port that the new command is queued in the host memory 23 may be output.

In an embodiment, the wake up signal may be output from the downstream port to the PCIe device based on the LN message. According to the wake up signal, the PCIe device may be changed from the L1.2 state to the L0 state (LOW POWER EXIT), which allows the PCIe device to be in a state capable of resuming the operation.

At this time, since the wake up signal is output based on the LN message before the SQ DOORBELL signal is output, it is possible to reduce time spent for the PCIe device to change its state from the L1.2 state to the L0 state.

Thereafter, when the PCIe device is in a state capable of resuming the operation, the SQ DOORBELL signal received from the NVMe driver 24 may be output to the PCIe device from the downstream port. In the L0 state, the PCIe device may fetch the command from the host memory 23.

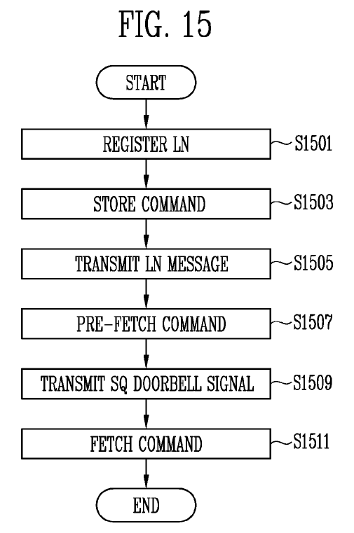

FIG. 15 is a diagram illustrating an operation of a PCIe device based on some implementations of the disclosed technology.

Referring to FIG. 15, in step S1501, the host may register the LN. The LN may indicate the address corresponding to a location where the command information is stored in the host memory of the host.

In step S1503, the host may store the command to be executed on the PCIe device. For example, the host may sequentially queue the command from the HEAD to the TAIL of the SUBMISSION QUEUE in the host memory.

In step S1505, the host may transmit the LN message to the PCIe device. That is, the host may indicate the position at which the new command is queued in the host memory. That is, the host may output the changed position to the PCIe device through the LN message when the position at which the command is queued is changed.

In step S1507, the PCIe device may pre-fetch the command queued in the host memory. When the PCIe device receives the LN message, the PCIe device may prepare to execute the command in advance through the pre-fetch of the command.

In step S1509, the host may transmit the SQ DOORBELL signal to the PCIe device. Thus, the host may output the SQ DOORBELL signal to the PCIe device so that the new command output from the host memory is identified. The PCIe device may perform the operation corresponding to the pre-fetched command based on the SQ DOORBELL signal.

In step S1511, the PCIe device may re-fetch the command queued in the host memory. For example, while the PCIe device performs the operation corresponding to the pre-fetched command, the command queued in the host memory may be fetched again. The PCIe device may perform the operation based on a result of comparing the pre-fetched command and the fetched command.

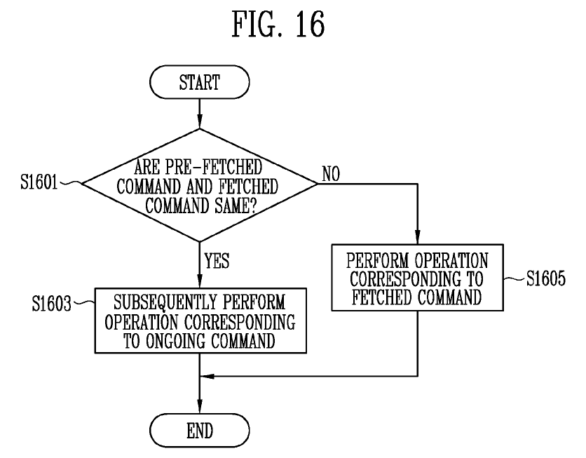

FIG. 16 is a diagram illustrating an operation of a PCIe device based on some implementations of the disclosed technology.

FIG. 16 shows steps after step S1511 of FIG. 15.

In step S1601, the PCIe device may determine whether the pre-fetched command and the fetched command are the same. The PCIe device may fetch the command again while performing the operation corresponding to the pre-fetched commands, and may compare the pre-fetched command and the fetched command.

When the pre-fetched command and the fetched command are the same (Y), the operation may proceed to step S1603, and the PCIe device may subsequently perform the operation corresponding to the ongoing command.

However, when the pre-fetched command and the fetched command are different (N), the operation may proceed to step S1605, and the PCIe device may stop the operation corresponding to the ongoing command and perform the operation corresponding to the newly fetched command.

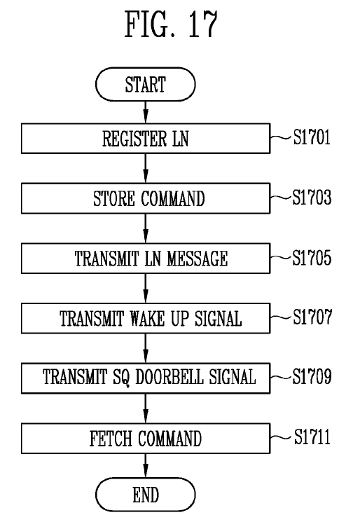

FIG. 17 is a diagram illustrating an operation of a PCIe device based on some implementations of the disclosed technology.

Referring to FIG. 17, in step S1701, the host may register the LN. The LN may indicate the address where the command information is stored in the host memory included in the host. At this time, the PCIe device may be in the L0 state. The L0 state may be a state in which power may be managed, and may be a state in which the data and the control packet are normally transmitted and received.

In step S1703, the host may store the command to be executed on the PCIe device. For example, the host may sequentially queue the command from the HEAD to the TAIL of the SUBMISSION QUEUE in the host memory. At this time, the PCIe device may be in the L1.2 state which is the low power state.

In step S1705, the host may transmit the LN message to the PCIe device through the downstream port. The LN message for informing the downstream port that the new command is queued in the host memory may be output. Here, the downstream port may be the port of the switch that is located relatively further from the root complex among the configurations included in the PCIe interface device.

In step S1707, the wake up signal output from the downstream port may be transmitted to the PCIe device. In order to change the state of the PCIe device from the L1.2 state to the L0 state, that is, the state in which the operation may be performed, the wake up signal may be output from the downstream port. According to the wake up signal, the PCIe device may be changed from the L1.2 state to the L0 state (LOW POWER EXIT), and the PCIe device may be in a state capable of performing the operation again.

In step S1709, the host may transmit the SQ DOORBELL signal to the PCIe device through the downstream port. When the PCIe device is in a state capable of performing the operation, the host may output the SQ DOORBELL signal to the PCIe device so that the new command output from the host memory is identified.

In step S1711, the PCIe device may fetch the command queued in the host memory. The PCIe device may fetch the command and perform the operation corresponding to the fetched command.

A preferred PCIe interface system and a method of operating the same, which reduces a time to fetch a command by registering a PCIe lightweight notification(LN) and prefetching the command is disclosed in U.S patent application Ser. No. 17/522,810, filed Nov. 9, 2021 and entitled, “PERIPHERAL COMPONENT INTERCONNECT EXPRESS (PCIE) INTERFACE SYSTEM AND METHOD OF OPERATING THE SAME”, the entire disclosure of which is incorporated herein by reference.

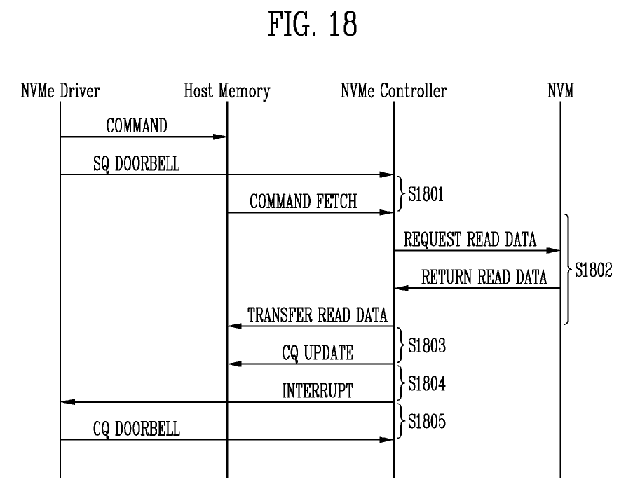

FIG. 18 illustrates an embodiment of a process for processing a read command in a PCIe system based on some implementations of the disclosed technology.

Referring to FIGS. 6 and 7, FIG. 18 shows an operation of a PCIe device. The PCIe device includes a non-volatile memory (NVM) and the NVMe controller 50 of FIG. 7. The NVMe controller 50 controls the NVM. The PCIe device is connected to each of the NVMe driver 24 of FIG. 7, the host memory 23 of FIG. 7. The PCIe device may be any one of the PCIe end points 15_1 and 15_2 or the legacy end points 16_1 and 16_2 in FIG. 1.

In an embodiment, the NVMe driver 24 may output the command to be executed on the PCIe device to the host memory 23, and the host memory 23 may sequentially queue the received command from the HEAD to the TAIL of the SUBMISSION QUEUE.

Thereafter, the NVMe driver 24 may output the SQ DOORBELL signal to the NVMe controller 50. The SQ DOORBELL signal may be the same signal as the SUBMISSION QUEUE TAIL DOORBELL signal of FIG. 7. Thus, the NVMe driver 24 may output the SQ DOORBELL signal to the NVMe controller 50 so that a new command output from the host memory 23 is identified.

In an embodiment, the NVMe controller 50 may fetch the command from the host memory 23 (COMMAND FETCH). Thus, the NVMe controller 50 may receive the commands queued in the SUBMISSION QUEUE from the host memory 23 and perform operations corresponding to the received commands.

For example, in FIG. 18, since the command to be executed on the PCIe device is the read command, the NVMe controller 50 may convert a logical block address (LBA) corresponding to the command into a physical block address (PBA), in response to the received command, and internally request read data to the NVM (REQUEST READ DATA). Thereafter, the NVMe controller 50 may receive the read data corresponding to the read data request from the NVM (RETURN READ DATA). In addition, the NVMe controller 50 may transmit the received read data to the host memory 23 (TRANSFER READ DATA). The NVMe driver 24 may perform an operation according to the received read data.

In an embodiment, after the PCIe device performs the operation corresponding to the commands, the NVMe controller 50 may update the COMPLETION QUEUE of the host memory 23 (CQ UPDATE). After the PCIe device performs the operation corresponding to the commands, the NVMe controller 50 may transmit the COMPLETION QUEUE ENTRY to the host memory 23, and the host memory 23 may sequentially queue the received COMPLETION QUEUE ENTRY from the HEAD to the TAIL of the SUBMISSION QUEUE.

Thereafter, the PCIe device may output the INTERRUPT signal to the NVMe driver 24. The INTERRUPT signal may be a signal indicating that the COMPLETION QUEUE ENTRY is queued in the COMPLETION QUEUE.

In an embodiment, when the operation performed by the NVMe driver 24 based on the COMPLETION QUEUE ENTRY of the COMPLETION QUEUE is completed, the NVMe driver 24 may output a CQ DOORBELL signal to the PCIe device. The CQ DOORBELL signal may be the same signal as the COMPLETION QUEUE HEAD DOORBELL signal of FIG. 7. Thus, the NVMe driver 24 may output the CQ DOORBELL signal to the PCIe device so that the command of which the operation is completed is identified.

Thereafter, the NVMe driver 24 may output a new command to be executed on the PCIe device to the host memory 23, and output the SQ DOORBELL signal to the PCIe device so that the new command output from the host memory 23 is identified.

In an embodiment, during a process of the read command, an idle time in which a state in which the packet is not transmitted and received through the link (LINK) may occurs. For example, the idle time may occur in any operation of S1801 to S1805.

In some implementations, the idle time may occur in any one or more operations that include 1) after the NVMe driver 24 outputs the SUBMISSION QUEUE TAIL DOORBELL signal and before fetching the command from the host memory 23 (COMMAND FETCH) (S1801), 2) after fetching the command from the host memory 23 (COMMAND FETCH) and before transmitting the read data to the host memory 23 (S1802), 3) after transmitting the read data to the host memory 23 and before updating the COMPLETION QUEUE (CQ UPDATE) (S1803), 4) after updating the COMPLETION QUEUE (CQ UPDATE) and before outputting the INTERRUPT signal (S1804), and/or 5) after outputting the INTERRUPT signal and before outputting the CQ DOORBELL signal (S1805).

In an embodiment, when the PCIe link power management is not performed or entered even when the idle state in which the packet is not transmitted and received through the link (LINK) continues, power may not be efficiently supplied to the PCIe device . In the conventional art, power supply was not efficient since the PCIe link power management can be entered only in a case that the entry does not exist in the SUBMISSION QUEUE and the COMPLETION QUEUE included in the host memory 23 and that the unprocessed command does not exist in the PCIe device.

Therefore, in the disclosed technology, techniques are suggested to sense or detect the idle state of the PCIe link by the PCIe device itself and enter the PCIe link power management in response to the detection of the idle state of the PCIe link. In some implementations, the PCIe device is configured to end and wake up the PCIe link power management by itself.

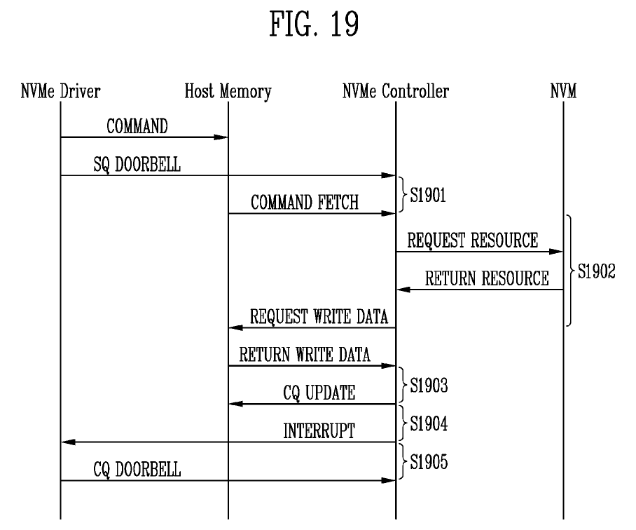

FIG. 19 illustrates an embodiment of a process for processing a write command in a PCIe system based on some implementations of the disclosed technology.

Referring to FIGS. 7 and 19, FIG. 19 shows an operation of a PCIe device. The PCIe device includes a non-volatile memory (NVM) and the NVMe controller 50 of FIG. 7. The NVMe controller 50 controls the NVM. The PCIe device is connected to each of the NVMe driver 24 of FIG. 7, the host memory 23 of FIG. 7. The PCIe device may be any one of the PCIe end points 15_1 and 15_2 or the legacy end points 16_1 and 16_2 in FIG. 1.

In an embodiment, the NVMe driver 24 may output the command to be executed on the PCIe device to the host memory 23, and the host memory 23 may sequentially queue the received command from the HEAD to the TAIL of the SUBMISSION QUEUE.

Thereafter, the NVMe driver 24 may output the SQ DOORBELL signal to the NVMe controller 50. The SQ DOORBELL signal may be the same signal as the SUBMISSION QUEUE TAIL DOORBELL signal of FIG. 7. That is, the NVMe driver 24 may output the SQ DOORBELL signal to the NVMe controller 50 so that a new command output from the host memory 23 is identified.

In an embodiment, the NVMe controller 50 may fetch the command from the host memory 23 (COMMAND FETCH). That is, the NVMe controller 50 may receive the commands queued in the SUBMISSION QUEUE from the host memory 23 and perform operations corresponding to the received commands.

For example, in FIG. 19, since the command to be executed on the PCIe device is the write command, the NVMe controller 50 may request resource allocation to the NVM, in response to the received command (REQUEST RESOURCE). The NVM may allocate a resource and a temporary buffer memory internally in response to the resource allocation request. When the allocation of the resource and the temporary buffer memory is completed, the NVM may return the resource (RETURN RESOURCE).

The NVMe controller 50 may output a write data request to the host memory 23 in order to store write data corresponding to the write command in the temporary buffer memory (REQUEST WRITE DATA). In response to the write data request, the host memory 23 may return the write data to the NVMe controller 50 (RETURN WRITE DATA), and the NVMe controller 50 may store the received write data in the temporary buffer memory and then perform an operation corresponding to the write command.

In an embodiment, after the NVMe controller 50 stores the received write data in the temporary buffer memory, the NVMe controller 50 may update the COMPLETION QUEUE of the host memory 23 (CQ UPDATE). Thus, the NVMe controller 50 may transmit the COMPLETION QUEUE ENTRY to the host memory 23, and the host memory 23 may sequentially queue the received COMPLETION QUEUE ENTRY from the HEAD to the TAIL of the SUBMISSION QUEUE.

Thereafter, the PCIe device may output the INTERRUPT signal to the NVMe driver 24. The INTERRUPT signal may be a signal indicating that the COMPLETION QUEUE ENTRY is queued in the COMPLETION QUEUE.

In an embodiment, when the operation performed by the NVMe driver 24 based on the COMPLETION QUEUE ENTRY of the COMPLETION QUEUE is completed, the NVMe driver 24 may output the CQ DOORBELL signal to the PCIe device. The CQ DOORBELL signal may be the same signal as the COMPLETION QUEUE HEAD DOORBELL signal of FIG. 7. Thus, the NVMe driver 24 may output the CQ DOORBELL signal to the PCIe device so that the command of which the operation is completed is identified.

Thereafter, the NVMe driver 24 may output a new command to be executed on the PCIe device to the host memory 23, and output the SQ DOORBELL signal to the PCIe device so that the new command output from the host memory 23 is identified.

In an embodiment, an idle time in which a state in which the packet is not transmitted and received through the link (LINK) continues during a process of the write command may occur. For example, the idle time may occur in any operation of S1901 to S1905.

In some implementations, the idle time may occur in any one or more operations that include 1) after the NVMe driver 24 outputs the SUBMISSION QUEUE TAIL DOORBELL signal and before fetching the command from the host memory 23 (COMMAND FETCH) (S1901), 2) after fetching the command from the host memory 23 (COMMAND FETCH) and before requesting the write data to the host memory 23 (S1902), 3) after transmitting the write data to the host memory 23 and before updating the COMPLETION QUEUE (CQ UPDATE) (S1903), 4) after updating the COMPLETION QUEUE (CQ UPDATE) and before outputting the INTERRUPT signal (S1904), and/or after outputting the INTERRUPT signal and before outputting the CQ DOORBELL signal (S1905).

In an embodiment, when the PCIe link power management is not performed or entered even when the idle state in which the packet is not transmitted and received through the link (LINK) continues, power may not be efficiently supplied to the PCIe device and the PCIe device. In the conventional art, power supply was not efficient since the PCIe link power management may be entered only in a case that the entry does not exist in the SUBMISSION QUEUE and the COMPLETION QUEUE included in the host memory 23 and that the unprocessed command does not exist in the PCIe device.

Therefore, in the disclosed technology, techniques are suggested to sense or detect the idle state of the PCIe link by the PCIe device itself and enter the PCIe link power management in response to the detection of the idle state of the PCIe interface link. In some implementations, then ends and wakes-up the PCIe link power management by itself, even in a case where the unprocessed command exists in the PCIe device, is presented.

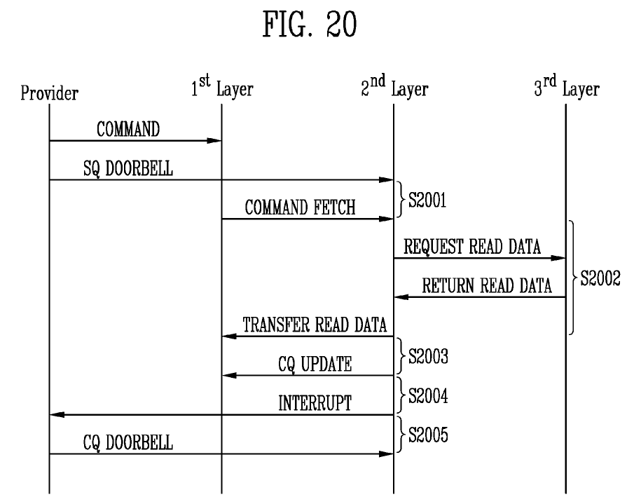

FIG. 20 illustrates an embodiment of a process for processing a read command in a PCIe system based on some implementations of the disclosed technology.

Referring to FIG. 20, FIG. 20 shows an operation between a provider and first to third layers. In FIG. 20, the provider may be any one of components included in the host 20 of FIG. 1 or any one of components of the PCIe device of FIG. 1.

In FIG. 20, the first to third layers may be the PCIe layer including the host memory 23, the PCIe layer including the NVMe controller 50 of FIG. 7, and the FTL Layer of the NVM. In an embodiment the PCIe device may include the NVMe controller 50 and the NVM.

In an embodiment, when the read command to be executed on the NVM is prepared in the first layer, in order to request a process of the corresponding read command, the provider may transmit an inbound write request packet (Downstream MemWr TLP) through the PCIe to transmit IO SQ tail update to the NVM.

In some implementations, the provider may output the command to be executed on the PCIe device to the first layer. For example, the NVMe driver 24 included in the provider may output the command to the first layer, and the first layer may sequentially queue the received command from the HEAD to the TAIL of the SUBMISSION QUEUE.

Thereafter, the provider may output the SQ signal DOORBELL to the second layer. For example, the NVMe driver 24 included in the provider may output the SQ DOORBELL signal to the NVMe controller 50. The SQ DOORBELL signal may be the same signal as the SUBMISSION QUEUE TAIL DOORBELL signal of FIG. 7. That is, the NVMe driver 24 included in the provider may output the SQ DOORBELL signal to the NVMe controller 50 so that a new command output from the first layer is identified.

In an embodiment, the second layer may sense the IO SQ tail update, and transmit an outbound read request packet (Upstream MemRd TLP) through the PCIe to fetch the command from the first layer (COMMAND FETCH). That is, the NVMe controller 50 included in the second layer may receive the commands queued in the SUBMISSION QUEUE from the first layer and perform operations corresponding to the received commands.

For example, in FIG. 20, since the command to be executed on the PCIe device is the read command, the second layer may convert the LBA corresponding to the command into the PBA and then internally request the read data to the third layer (REQUEST READ DATA).

Thereafter, when the operation corresponding to the read command is internally completed, the read data may be stored in the temporary buffer memory of the NVM. In order to transmit the read data to the first layer, the NVM may transmit the read data by including the read data in an outbound write request packet (Upstream MemWr TLP) through the PCIe.

For example, the second layer may receive the read data corresponding to the read data request from the third layer of the NVM (RETURN DATA READ). In addition, the second layer may transmit the received read data to the first layer (READ DATA TRANSFER). The provider may perform an operation according to the received read data.

In an embodiment, when the transmission of the read data to the first layer is completed, in order to transmit that the execution of the corresponding read command is successfully completed to the first layer, the NVM may transmit the COMPLETION QUEUE ENTRY through the PCIe by including the COMPLETION QUEUE ENTRY in the outbound write request packet (Upstream MemWr TLP).

For example, after the PCIe device performs the operation corresponding to the commands, the second layer may update the COMPLETION QUEUE of the first layer (CQ UPDATE). After the PCIe device performs the operation corresponding to the commands, the second layer may transmit the COMPLETION QUEUE ENTRY to the first layer, and the first layer may sequentially queue the received COMPLETION QUEUE ENTRY from the HEAD to the TAIL of the COMPLETION QUEUE.

Thereafter, the NVM may output an INTERRUPT message to the provider by including the INTERRUPT message in the outbound write request packet (Upstream MemWr TLP) through the PCIe to inform the provider that the COMPLETION QUEUE ENTRY is newly transmitted.

For example, the second layer may output the INTERRUPT signal to the provider. The INTERRUPT signal may be a signal informing the COMPLETION QUEUE that the COMPLETION QUEUE ENTRY is queued.

In an embodiment, in order to inform that the COMPLETION QUEUE ENTRY is received from the NVM and is processed, the provider may transmit the inbound write request packet (Downstream MemWr TLP) through the PCIe to transmit IO CQ head update to the NVM.

For example, when the provider completes an operation based on the COMPLETION QUEUE ENTRY of the COMPLETION QUEUE, the provider may output the CQ DOORBELL signal to the second layer. The CQ DOORBELL signal may be the same signal as the COMPLETION QUEUE HEAD DOORBELL signal of FIG. 7. Thus, the provider may output the CQ DOORBELL signal to the PCIe device so that the command of which the operation is completed is identified.

Thereafter, the provider may output a new command to be executed on the PCIe device to the first layer, and output the SQ DOORBELL signal to the second layer so that the new command output from the first layer is identified.

In an embodiment, an idle time in which a state in which the packet is not transmitted and received through the link (LINK) occurs during a process of the read command. For example, the idle time may be generated in any operation of S2001 to S2005.

In some implementations, the idle time may occur in any one or more operations that include 1) after the provider outputs the SUBMISSION QUEUE TAIL DOORBELL signal and before fetching the command from the first layer (COMMAND FETCH) (S2001), 2) after fetching the command from the first layer (COMMAND FETCH) and before transmitting the read data to the first layer (S2002), 3) after transmitting the read data to the first layer and before updating the COMPLETION QUEUE (CQ UPDATE) (S2003), 4) after updating the COMPLETION QUEUE (CQ UPDATE) and before outputting the INTERRUPT signal (S2004), and/or 5) after outputting the INTERRUPT signal and before outputting the CQ DOORBELL signal (S2005).

In an embodiment, when the PCIe link power management is not performed or entered even when the idle state in which the packet is not transmitted and received through the link (LINK) continues, power may not be efficiently supplied to the PCIe device and the PCIe device. In the conventional art, power supply was not efficient since the PCIe link power management may be entered only in a case that the entry does not exist in the SUBMISSION QUEUE and the COMPLETION QUEUE included in the first layer and that the unprocessed command does not exist in the PCIe device.

Therefore, in the disclosed technology, techniques are suggested to sense or detect the idle state of the PCIe link by the PCIe device itself and enter the PCIe link power management in response to the detection of the idle state of the PCIe link. In some implementations, the PCIe device is configured to end and wake-up the PCIe link power management by itself.

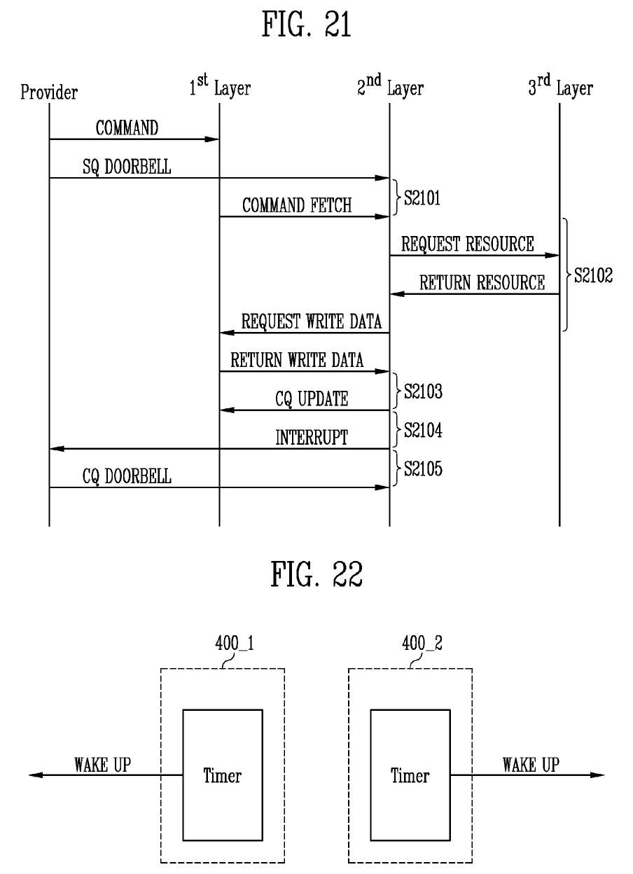

FIG. 21 illustrates an embodiment of a process for processing write command in a PCIe system based on some implementations of the disclosed technology.

Referring to FIG. 21, FIG. 21 shows an operation between the provider and the first to third layers. In FIG. 21, the provider may be any one of the components included in the host 20 of FIG. 1 or any one of the components of the PCIe device of FIG. 1.

In FIG. 21, the first to third layers may be the PCIe layer including the host memory 23, the PCIe layer including the NVMe controller 50 of FIG. 7, and the FTL Layer of the NVM. In an embodiment the PCIe device may include the NVMe controller 50 and the NVM.

In an embodiment, when the write command to be executed on the NVM is prepared in the first layer, in order to request a process of the corresponding write command, the provider may transmit the inbound write request packet (Downstream MemWr TLP) through the PCIe to transmit the IO SQ tail update to the NVM.

Specifically, the provider may output the command to be executed on the PCIe device to the first layer. For example, the NVMe driver 24 included in the provider may output the command to the first layer, and the first layer may sequentially queue the received command from the HEAD to the TAIL of the SUBMISSION QUEUE.

Thereafter, the provider may output the SQ signal DOORBELL to the second layer. Specifically, the NVMe driver 24 included in the provider may output the SQ DOORBELL signal to the NVMe controller 50. The SQ DOORBELL signal may be the same signal as the SUBMISSION QUEUE TAIL DOORBELL signal of FIG. 7. That is, the NVMe driver 24 included in the provider may output the SQ DOORBELL signal to the NVMe controller 50 so that the new command output from the first layer is identified.

In an embodiment, the second layer may sense the IO SQ tail update, and transmit the outbound read request packet (Upstream MemRd TLP) through the PCIe to fetch the command from the first layer (COMMAND FETCH). That is, the NVMe controller 50 included in the second layer may receive the commands queued in the SUBMISSION QUEUE from the first layer and perform operations corresponding to the received commands.

For example, in FIG. 21, since the command to be executed on the PCIe device is the write command, the second layer may request resource allocation to the NVM, in response to the received command (REQUEST RESOURCE). The NVM may allocate the resource and the temporary buffer memory internally in response to the resource allocation request. When the allocation of the resource and the temporary buffer memory is completed internally, the second layer may return the resource (RETURN RESOURCE).

In an embodiment, the second layer may output the write data request to the first layer in order to store the write data corresponding to the write command in the temporary buffer memory (REQUEST WRITE DATA). In response to the write data request, the first layer may return the write data to the second layer (RETURN WRITE DATA), and the second layer may store the received write data in the temporary buffer memory and then perform the operation corresponding to the write command.

In an embodiment, when the storage of the write data in the temporary buffer memory (or the NVM) is completed, in order to transmit that the execution of the corresponding command is successfully completed to the first layer, the second layer may transmit the COMPLETION QUEUE ENTRY through the PCIe by including the COMPLETION QUEUE ENTRY in the outbound write request packet (Upstream MemWr TLP).

For example, after the second layer stores the received write data in the temporary buffer memory, the second layer may update the COMPLETION QUEUE of the first layer (CQ UPDATE). That is, the second layer may transmit the COMPLETION QUEUE ENTRY to PCIe layer, and the first layer may sequentially queue the received COMPLETION QUEUE ENTRY from the HEAD to the TAIL of the COMPLETION QUEUE.

Thereafter, the NVM may output the INTERRUPT message to the provider by including the INTERRUPT message in the outbound write request packet (Upstream MemWr TLP) through the PCIe to inform the provider that the COMPLETION QUEUE ENTRY is newly transmitted.

For example, the second layer may output the INTERRUPT signal to the provider. The INTERRUPT signal may be a signal informing the COMPLETION QUEUE that the COMPLETION QUEUE ENTRY is queued.

In an embodiment, in order to inform that the COMPLETION QUEUE ENTRY is received from the NVM and is processed, the provider may transmit the inbound write request packet (Downstream MemWr TLP) through the PCIe to transmit the IO CQ head update to the NVM.

For example, when the provider completes the operation based on the COMPLETION QUEUE ENTRY of the COMPLETION QUEUE, the provider may output the CQ DOORBELL signal to the PCIe device. The CQ DOORBELL signal may be the same signal as the COMPLETION QUEUE HEAD DOORBELL signal of FIG. 7. That is, the provider may output the CQ DOORBELL signal to the PCIe device so that the command of which the operation is completed is identified.

Thereafter, the provider may output the new command to be executed on the PCIe device to the PCIe layer, and output the SQ DOORBELL signal to the PCIe device so that the new command output from the PCIe layer is identified.

In an embodiment, an idle time in which the packet is not transmitted and received through the link (LINK) occurs during a process of the write command. For example, the idle time may occur in any operation of S2101 to S2105.

In some implementations, the idle time may occur in any one or more operations that include 1) after the provider outputs the SUBMISSION QUEUE TAIL DOORBELL signal and before fetching the command from the first layer (COMMAND FETCH) (S2101), 2) after fetching the command from the first layer (COMMAND FETCH) and before requesting the write data to the first layer (S2102), 3) after transmitting the write data to the second layer and before updating the COMPLETION QUEUE (CQ UPDATE) (S2103), 4) after updating the COMPLETION QUEUE (CQ UPDATE) and before outputting the INTERRUPT signal (S2104), and/or 5) after outputting the INTERRUPT signal and before outputting the CQ DOORBELL signal (S2105).

In an embodiment, when the PCIe link power management is not performed or entered even when the idle state in which the packet is not transmitted and received through the link (LINK) continues, power may not be efficiently supplied to the PCIe device and the PCIe device. In the conventional art, power supply was not efficient since the PCIe link power management can be entered only in a case that the entry does not exist in the SUBMISSION QUEUE and the COMPLETION QUEUE included in the host memory 23 and that the unprocessed command does not exist in the PCIe device.

Therefore, in the disclosed technology, techniques are suggested to sense or detect the idle state of the PCIe link by the PCIe device itself and enter the PCIe link power management in response to the detection of the idle state of the PCIe link. In some implementations, the PCIe device is configured to end and wake-up the PCIe link power management by itself.

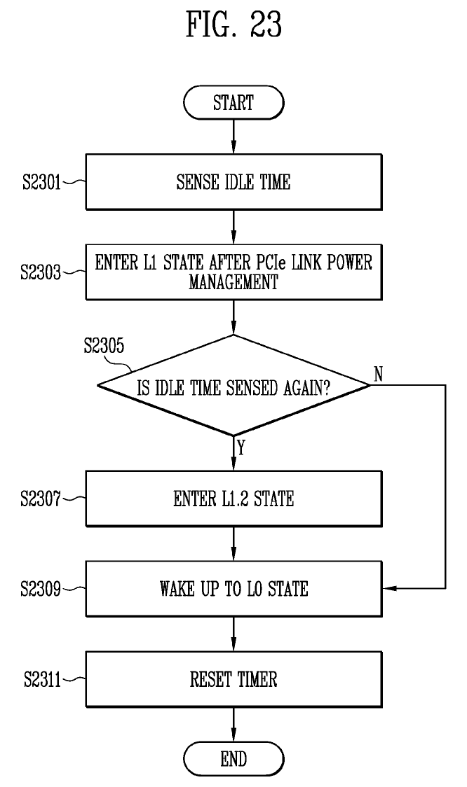

FIG. 22 illustrates timers included in the PCIe device.

Referring to FIGS. 2 and 11, FIG. 22 shows timers included in the PCI components 400_1 and 400_2, respectively. The timer may be included in the transaction layer, the data link layer, or the physical layer, or may be positioned outside.

In an embodiment, the timers may sense or detect time in which the packet is not transmitted and received through the link (LINK) of the PCIe continues. Thus, the timer may sense or detect the idle state of the link (LINK).

In an embodiment, when the timer sense or detect the state in which the packet is not transmitted and received through the link (LINK) during a preset reference time, the PCIe device of FIG. 1 may automatically enter the PCIe link power management. The PCIe device of FIG. 1 may be changed to the L1 state after the PCIe link power management.

Thereafter, when the timers sense or detect that the state in which the packet is not transmitted and received through the link (LINK) during the preset reference time again, the PCIe device may be changed to the L1.2 state. The L1.2 state may be the sub state of the L1 state. The L1.2 state may be a state in which a link common mode voltage is not required to be maintained and there is no need to activate an upstream port and a downstream port to sense or detect release of the idle state.

In an embodiment, when the PCIe device enters a state capable of performing an operation such as fetching the command from the host memory 23 (COMMAND FETCH) and the idle state of the link (LINK) is released, the timers may output a WAKE UP signal to be changed to the L0 state. That is, when a state in which the packet may be transmitted and received through the link (LINK) is reached, based on the WAKE UP signal, the PCIe link power management may be ended, and the transaction layer, the data link layer, or the physical layer may perform an operation again. As the PCIe link power management is ended, the PCIe device may be changed from the L1 state or L1.2 state to the L0 state.

Thereafter, when the PCIe device performs an operation such as fetching the command from the host memory 23 (COMMAND FETCH), the timer may be reset. That is, when the packet is transmitted and received through the link (LINK), the timer may be reset. When the timer is reset, the timer may sense or detect the state in which the packet is not transmitted and received through the link (LINK) during the preset reference time.

In another embodiment, contents described above may be applied to a processor (ex. Admin command) corresponding to a command other than the read command or the write command). In addition, more power may be saved by partially managing power according to a command lifetime not only the PCIe link power management, but also a host layer, an FTL layer, and the like inside a device. Furthermore, even though the host 20 of FIG. 1 outputs CQ head update late, the PCIe link power management may be performed in advance.

As a result, power can be efficiently supplied by performing the PCIe link power management even during a process of the command.

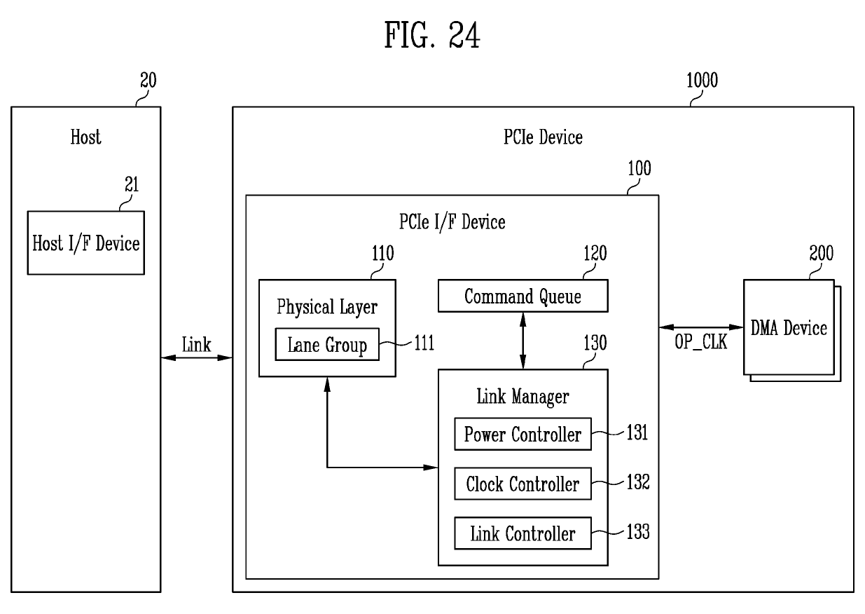

FIG. 23 is a diagram illustrating an operation of a PCIe device according to an embodiment of the disclosed technology.

Referring to FIG. 23, in step S2301, the PCIe device may sense or detect the idle time. The idle time may be a preset reference time, and may be a time in which the packets is not transmitted and received through the PCIe link (LINK) continues.

When the PCIe device senses or detects the idle time, in step S2303, the PCIe device may enter the L1 state after the PCIe link power management. The L1 state may have a speed for returning to the L0 state lower than that of the L0 state, but may be a state in which additionally greater power may be saved compared to the L0 state through an additional resume latency in the L1 state.

In step S2305, the PCIe device may determine whether the idle time is sensed or detected again. When the idle time is not sensed or detected (N), the operation proceeds to step S2309, and when the idle time is sensed or detected (Y), the operation proceeds to step S2307.

In step S2307, the PCIe device may enter the L1.2 state. The L1.2 state may be the sub state of the L1 state. The L1.2 state may be a state in which a link common mode voltage is not required to be maintained and there is no need to activate an upstream port and a downstream port to sense or detect the release of the idle state.

In step S2309, the PCIe device may wake up to the L0 state. That is, when a state in which an operation such as fetching the command is performed is reached and the idle state of the PCIe link (LINK) is not sensed or detected, the PCIe device may be woken up to perform an operation.

Thereafter, when the operation such as fetching the command is completed, the timer may be reset in step S2311.

A preferred PCIe interface device and a method of operating the same, which perform PCIe link power management in response to detecting an idle state of a PCIe link during a process of a nonvolatile memory express (NVMe) command is disclosed in U.S patent application Ser. No. 17/522,827, filed Nov. 9, 2021 and entitled, “PERIPHERAL COMPONENT INTERCONNECT EXPRESS (PCIE) INTERFACE DEVICE AND METHOD OF OPERATING THE SAME”, the entire disclosure of which is incorporated herein by reference.

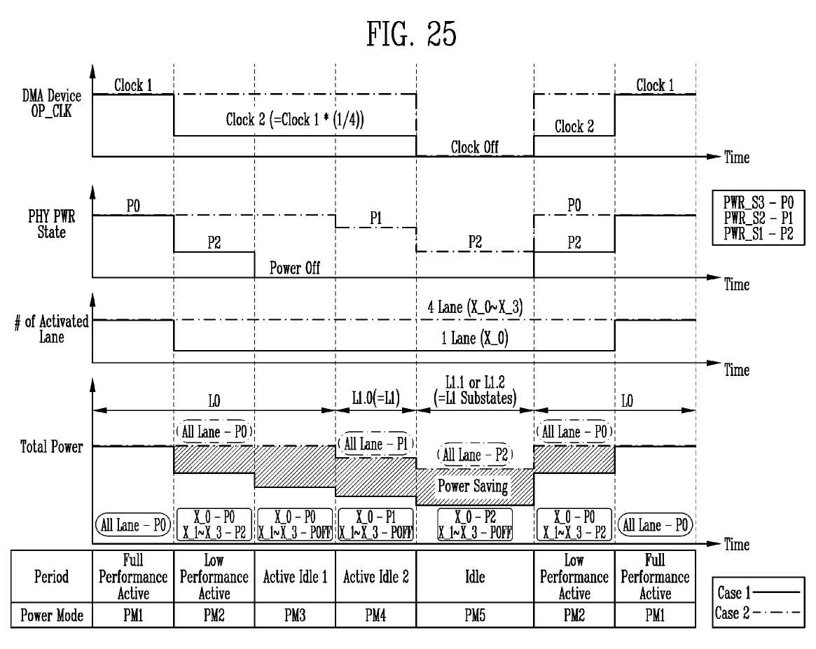

FIG. 24 is a diagram illustrating a structure of a PCIe device and communication with a host based on an embodiment of the disclosed technology.

Referring to FIG. 24, the PCIe device 1000 may include a PCIe interface device 100 and at least one direct memory access (DMA) device 200.

The host 20 may include a host interface (I/F) device 21.

The PCIe device 1000 and the host 20 may communicate with each other using the PCIe interface device 100 and the host interface device 21, respectively. The PCIe interface device 100 and the host interface device 21 may form a link for communication. The link may include lanes connected between the PCIe interface device 100 and the host interface device 21. The PCIe interface device 100 may transmit and receive data to and from the host interface device 21 through the link. In an embodiment, the host 20 may correspond to the first PCIe component 400_1 described with reference to FIG. 2. The PCIe device 1000 may correspond to the second PCIe component 400_2.

In an embodiment, the PCIe interface device 100 may include a physical layer 110, a command queue 120, and a link manager 130.

The physical layer 110 may form the link for communication with the host 20. The physical layer 110 may include a lane group 111. The lane group 111 may include a default lane and at least one or more lanes.

The command queue 120 may store commands for at least one DMA device 200, which are generated based on a request of the host 20.

When an amount of the commands stored in the command queue 120 is less than or equal to a reference value, the link manager 130 may change an operation mode from a first power mode to a second power mode. The second power mode may be a power mode in which power consumption is less than that of the first power mode among a plurality of power modes. In the second power mode, the link manager 130 may deactivate at least one or more lanes and provide a second operation clock lower than a first operation clock to the DMA device 200.

In an embodiment, the link manager 130 may include a power controller 131, a clock controller 132, and a link controller 133.

When the amount of the commands stored in the command queue is greater than the reference value, the power controller 131 may set the operation mode to the first power mode among the plurality of power modes. The plurality of power modes may include first to fifth power modes. The power consumption may be decreased in an order from the first power mode to the fifth power mode. Although the present embodiment has five power modes, the number of the plurality of power modes is not limited thereto and other implementations are also possible.

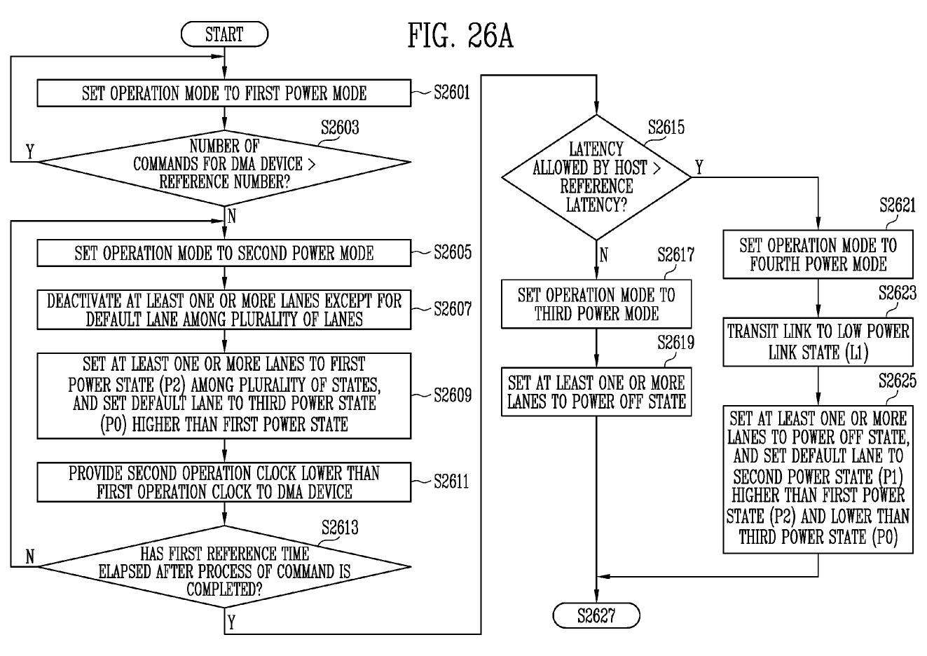

When the amount of the commands stored in the command queue is less than or equal to the reference value, the power controller 131 may set the operation mode to the second power mode. The power controller 131 may set the operation mode to the third power mode when the command queue is empty during a first time period that is equal to or more than a first reference time and a latency allowed by the host 20 is less than or equal to a reference latency. The first reference time may be a reference time for determining whether to enter an active-idle period described with reference to FIG. 25. The power controller 131 may set the operation mode to the fourth power mode when the command queue is empty during the first time period that is equal to or more than the first reference time and the latency allowed by the host 20 is greater than the reference latency. The power controller 131 may set the operation mode to the fifth power mode when the command queue is empty during a second time period that is equal to or more than a second reference time. The second reference time may be a reference time for determining whether to enter an idle period described with reference to FIG. 25. The second reference time may be greater than the first reference time.

The power controller 131 may set the default lane and at least one or more lanes to any one of a plurality of power states. The plurality of power states may include first to third power states. The power consumption may be increased in an order from the first power state to the third power state. The number of the plurality of power states is not limited to the present embodiment.

In the first power mode, the power controller 131 may set the default lane and at least one or more lanes to the third power state. In the second power mode, the power controller 131 may maintain the default lane as the third power state. In the second power mode, the power controller 131 may set at least one or more lanes to the first power state. In the third power mode, the power controller 131 may maintain the default lane as the third power state and set at least one or more lanes to a power off state. During the power off state, the power is not supplied and thus, the device is powered off. In the fourth power mode, the power controller 131 may set the default lane to the second power state and set at least one or more lanes to the power off state. In the fifth power mode, the power controller 131 may set the default lane to the first power state and set at least one or more lanes to the power off state.

In the first power mode, the clock controller 132 may provide the first operation clock to the DMA device 200. In the second to fourth power modes, the clock controller 132 may provide the second operation clock to the DMA device 200. The second operation clock may be an operation clock obtained by decreasing the first operation clock by a ratio of the number of activated lanes to a total number of lanes included in the lane group. Since the lane group includes the default lane and the at least one or more lanes, the total number of lanes corresponds to a sum of the number of the at least one or more lanes and one (i.e., the number of the default lane).

In the first to third power modes, the link controller 133 may maintain the link as the L0 state which is the normal link state. In the fourth power mode, the link controller 133 may transit the link to the L1 state which is the low power link state. In the fifth power mode, the link controller 133 may transit the link to a sub state of L1, which is the low power link sub state.

The DMA device 200 may perform data communication based on an operation clock OP_CLK provided from the PCIe device 1000.

A type of the DMA device 200 may include a non-volatile memory express (NVMe) device, a solid state drive (SSD) device, an artificial intelligence central processing unit (AI CPU), an artificial intelligence system on chip (AI SoC), Ethernet device, a sound card, a graphic card, and the like. The type of the DMA device 200 is not limited thereto, and may include other electronic devices using a PCIe communication protocol.

FIG. 25 is a diagram illustrating power management of the PCIe interface device described with reference to FIG. 24.

Referring to FIG. 25, the lane group may include first to fourth lanes X_0 to X_3. The number of lanes included in the lane group is not limited to the present embodiment and other implementations are also possible. The first lane X_0 may be the default lane.

In FIG. 25, the plurality of power modes may include first to fifth power modes PM1 to PM5. The number of the plurality of power modes is not limited to the present embodiment. The power consumption may be decreased in an order from the first power mode PM1 to the fifth power mode PM5.

In a full performance active period, the operation mode may be set to the first power mode PM1. In a low performance active period, the operation mode may be set to the second power mode PM2. In a first active idle period, the operation mode may be set to the third power mode PM3. In a second active idle period, the operation mode may be set to the fourth power mode PM4. In an idle period, the operation mode may be set to the fifth power mode PM5.

When the number of commands stored in the command queue is less than or equal to the reference value, the operation mode may be changed from the first power mode PM1 to the second power mode PM2. When a first reference time elapses from a time point when a process of all commands stored in the command queue is completed, the operation mode may be changed from the second power mode PM2 to the third power mode PM3. When the first reference time elapses from the time point when the process of all commands stored in the command queue is completed and the latency allowed by the host is greater than the reference latency, the operation mode may be changed from the third power mode PM3 to the fourth power mode PM4. When a second reference time elapses from the time point when the process of all commands stored in the command queue is completed, the operation mode may be changed from the fourth power mode PM4 to the fifth power mode PM5. The second reference time may be greater than the first reference time. When a new command is generated according to the request of the host, the operation mode may be changed from the fifth power mode PM5 to the second power mode PM2. When the number of generated new commands is greater than the reference value, the operation mode may be changed from the second power mode PM2 to the first power mode PM1.

The plurality of power states may include first to third power states PWR_S1 to PWR_S3. The number of the plurality of power states is not limited to the present embodiment. The power consumption may be increased in an order from the first power state PWR_S1 to the third power state PWR_S3. The first power state PWR_S1 may be a P2 state. The second power state PWR_S2 may be a P1 state. The third power state PWR_S3 may be a P0 state. In an embodiment, the power state may be set for each lane.

In the P0 state, the operation clock PCLK of the lane described with reference to FIG. 24 must stay operational. Internal clocks of the physical layer 110 except for the lane may be operational. The internal clocks of the physical layer 110 and the operation clock PCLK of the lane may be separate clocks. The physical layer 110 may transmit and receive PCI express signaling. The operation clock PCLK of the lane may vary according to Gen Speed of the PCIe device.

In the P1 state, a selected internal clock among the internal clocks of the physical layer 110 may be turned off. The operation clock PCLK of the lane must stay operational. Both of a transmit channel and a reception channel may be idle. The P1 state may be used in the disabled state, the detect state, and the L1 state described with reference to FIG. 4A.

In the P2 state, a selected internal clock among the internal clocks of the physical layer 110 may be turned off. The operation clock PCLK of the lane is turned off. A parallel interface may operate in an asynchronous mode. The P2 state may be used in the L1 state, the L2 state described with reference to FIG. 4A, and the sub state of L1 described with reference to FIG. 4B.

Regarding a first case, a first operation clock Clock 1 may be provided to the DMA device from the full performance active period to the low performance active period and the first active idle period. The first to fourth lanes X_0 to X_3 may be set to the P0 state. The link may maintain the L0 state.

In the second active idle period, the first operation clock Clock 1 may be provided to the DMA device. The first to fourth lanes X_0 to X_3 may be set to the P1 state. The link may transit to the L1 state.

In the idle period, the operation clock provided to the DMA device may be turned off. The first to fourth lanes X_0 to X_3 may be set to the P2 state. The link may transit to the sub state of L1.

Regarding a second case, in the full performance active period, the first operation clock Clock 1 may be provided to the DMA device. The first to fourth lanes X_0 to X_3 may be set to the P0 state. The link may maintain the L0 state.

In the low performance active period, a second operation clock Clock 2 may be provided to the DMA device. The second operation clock Clock 2 may be the operation clock obtained by decreasing the first operation clock Clock 1 by the ratio of the number of activated lanes to the total number of lanes included in the lane group. In FIG. 25, the second operation clock Clock 2 may be an operation clock obtained by decreasing the first operation clock Clock 1 to 1/4. The first lane X_0 may be set to the P0 state. The second to fourth lanes X_1 to X_3 may be set to the P2 state. The link may maintain the L0 state.

In the first active idle period, the second operation clock Clock 2 may be provided to the DMA device. The first lane X_0 may be set to the P0 state. The second to fourth lanes X_1 to X_3 may be set to the power off state. The link may maintain the L0 state.

In the second active idle period, the second operation clock Clock 2 may be provided to the DMA device. The first lane X_0 may be set to the P1 state. The second to fourth lanes X_1 to X_3 may be set to the power off state. The link may transit to the L1 state.

In the idle period, the operation clock provided to the DMA device may be turned off. In various embodiments, a very low operation clock may be provided to the DMA device. The first lane X_0 may be set to the P2 state. The second to fourth lanes X_1 to X_3 may be set to the power off state. The link may transit to the sub state of L1.

From the low performance active period to the idle period, in the case of the first case, the first to fourth lanes X_0 to X_3 may be activated. In the case of the second case, only the first lane X_0, which is the default lane, may be activated, and the second to fourth lanes X_1 to X_3 may be deactivated. Therefore, the second case may reduce power consumption compared to the first case.

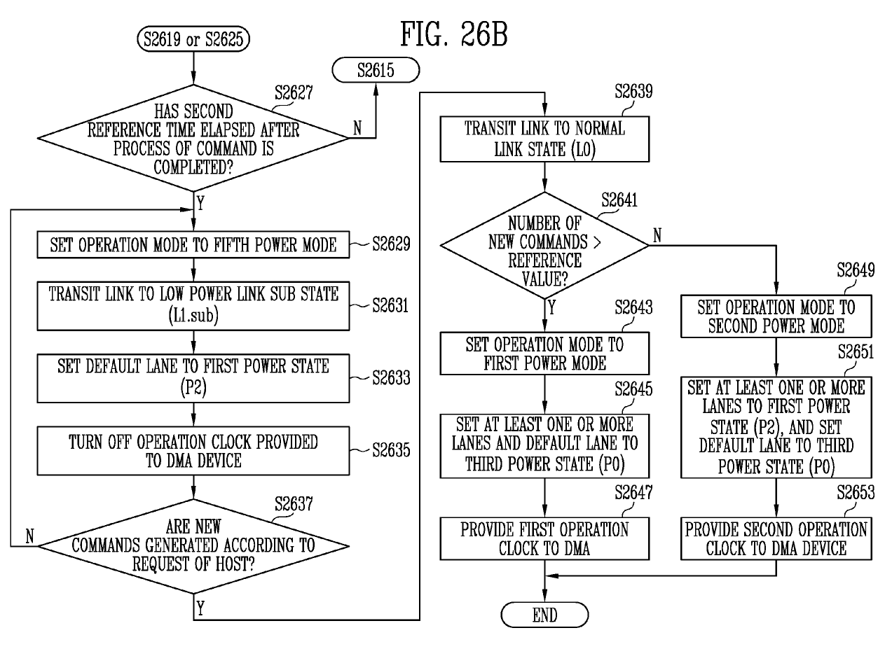

FIGS. 26A and 26B are flowcharts illustrating an operation of the PCIe device.

Referring to FIG. 26A, in step S2601, the PCIe interface device may set the operation mode to the first power mode among the plurality of power modes. The first power mode may be a power mode having the highest power consumption among the plurality of power modes.

In step S2603, the PCIe interface device may determine whether the number of commands for the DMA device is greater than the reference value. As a result of the determination, when the number of commands is greater than the reference value, the operation proceeds to step S2601, and when the number of commands is less than or equal to the reference value, the operation proceeds to step S2605.

In step S2605, the PCIe interface device may set the operation mode to the second power mode in which the power consumption is less than that of the first power mode among the plurality of power modes.

In step S2607, the PCIe interface device may deactivate at least one or more lanes except for the default lane among the plurality of lanes.

In step S2609, the PCIe interface device may set at least one or more lanes to the first power state P2 among the plurality of power states, and set the default lane to the third power state P0 higher than the first power state P2. The third power state P0 may be the highest level among the plurality of power states.

In step S2611, the PCIe interface device may provide the second operation clock lower than the first operation clock to the DMA device. The second operation clock may be the clock obtained by decreasing the first operation clock by the ratio of the number of activated lanes to the total number of lanes included in the lane group.

In step S2613, the PCIe interface device may determine whether the first reference time elapses after the process of all commands for the DMA device described in step S2603 is completed. The first reference time may be a reference time for determining whether to enter the active-idle period described with reference to FIG. 25.

In step S2615, the PCIe interface device may determine whether the latency allowed by the host is greater than the reference latency. As a result of the determination, when the latency allowed by the host is greater than the reference latency, the operation proceeds to step S2621, and when the latency allowed by the host is less than or equal to the reference latency, the operation proceeds to step S2617.

In step S2617, the PCIe interface device may set the operation mode to the third power mode in which the power consumption is less than that of the second power mode.

In step S2619, the PCIe interface device may set at least one or more inactive lanes to the power off state.

In step S2621, the PCIe interface device may set the operation mode to the fourth power mode in which the power consumption is less than that of the third power mode.

In step S2623, the PCIe interface device may transit the link to the L1 state.

In step S2625, the PCIe interface device may turn off power of at least one or more lanes, and set the power of the default lane to the second power state P1 higher than the first power state and lower than the third power state.

Referring to FIG. 26B, step S2619 or step S2625 may proceed to step S2627.

In step S2627, the PCIe interface device may determine whether the second reference time elapses after the process of all commands for the DMA device described above in step S2603 is completed. The second reference time may be a reference time for determining whether to enter the idle period described with reference to FIG. 25. The second reference time may be greater than the first reference time.

In step S2629, the PCIe interface device may set the operation mode to the fifth power mode. The fifth power mode may be a power mode having the lowest power consumption among the plurality of power modes.

In step S2631, the PCIe interface device may transit the link to the low power link sub state. The low power link sub state may include the L1.1 sub state and the L1.2 sub state described with reference to FIG. 4B.

In step S2633, the PCIe interface device may set the default lane to the first power state P2. The first power state P2 may be the lowest level among the plurality of power states.

In step S2635, the PCIe interface device may turn off the operation clock provided to the DMA device.

In step S2637, the PCIe interface device may determine whether the new commands for the DMA device are generated according to the request of the host. As a result of the determination, when the new commands are generated, the operation proceeds to step S2639, and when the new commands are not generated, the operation proceeds to step S2629.

In step S2639, the PCIe interface device may transit the link to the normal link state L0.

In step S2641, the PCIe interface device may determine whether the number of new commands generated in step S2637 is greater than the reference value. As a result of the determination, when the number of new commands is greater than the reference value, the operation proceeds to step S2643, and when the number of new commands is less than or equal to the reference value, the operation proceeds to step S2649.

In step S2643, the PCIe interface device may set the operation mode to the first power mode.

In step S2645, the PCIe interface device may set at least one or more lanes and the default lane to the third power state P0.

In step S2647, the PCIe interface device may provide the first operation clock to the DMA device.

In step S2649, the PCIe interface device may set the operation mode to the second power mode.

In step S2651, the PCIe interface device may set at least one or more lanes to the first power state P2 and set the default lane to the third power state P0.

In step S2653, the PCIe interface device may provide the second operation clock to the DMA device.

Examples of embodiments of the disclosed technology for systems with a host and one or more memory devices and interfacing between a host and a memory device are described. Variations and improvements of the disclosed embodiments and other embodiments may be made based on what is described or illustrated in this document.

A preferred PCIe interface device having improved power management performance, and a method of operating the same is disclosed in U.S patent application Ser. No. 17/522,843, filed Nov. 9, 2021 and entitled, “PERIPHERAL COMPONENT INTERCONNECT EXPRESS (PCIE) INTERFACE DEVICE AND METHOD OF OPERATING THE SAME”, the entire disclosure of which is incorporated herein by reference.

What is claimed is:

1. A computing system comprising:
a host; and
a peripheral component interconnect express (PCIe) device connected to the host through a link,
wherein the host comprises:
a host memory configured to store information on a first target command to be executed in the PCIe device; and
a storage device driver configured to provide the first target command to the host memory and a notification message indicating that the first target command is stored in the host memory to the PCIe device;
wherein the PCIe device is configured to request the host memory to register an address of the host memory in which a second target command to be executed in the PCIe device is stored through a preset protocol.

2. The computing system of claim 1, wherein the notification message includes a submission queue (SQ) doorbell message.

3. The computing system of claim 1, wherein the preset protocol includes a lightweight notification (LN) protocol.

4. The computing system of claim 3, wherein the host memory is configured to provide an LN message indicating that the second target command is stored in the address to the PCIe device.

5. The computing system of claim 4, wherein the PCIe device is configured to prefetch the second target command after receiving the LN message and perform a second operation corresponding to the second target command.

6. The computing system of claim 5, wherein the PCIe device is configured to fetch the first target command from the host memory when the notification message is received from the storage device driver while performing the second operation.

7. The computing system of claim 6, wherein the PCIe device is configured to determine whether to proceed the second operation according to a comparison between the fetched first target command and the prefetched second target command.

8. The computing system of claim 7, wherein the PCIe device is configured to stop the second operation and perform a first operation corresponding to the first target command when the first target command is different from the second target command.

9. The computing system of claim 7, wherein the PCIe device is configured to proceed the second operation when the first target command matches the second target command.

10. The computing system of claim 4, wherein the PCIe device is configured to change a power state of the link from a normal state to a low power state when an idle state in which packets are not transmitted and received with the host through the link for a reference time is detected.

11. The computing system of claim 10, wherein the PCIe device is configured to change the power state of the link to the normal state when receiving the LN message while the power of the link is in the low power state.

12. The computing system of claim 10, wherein the PCIe device comprises:
a direct memory access (DMA) device; and
a peripheral component interconnect express (PCIe) interface device configured to include a lane group forming the link between the host and the DMA device, when the power of the link is changed from the normal state to the low power state, deactivate at least one lane other than a default lane among a plurality of lanes included in the lane group and provide a second operation clock lower than a first operation clock to the DMA device.

13. The computing system of claim 12, wherein the second operation clock is obtained by reducing the first operation clock by a ratio of a number of activated lanes to a total number of lanes included in the lane group.
